(19) United States
(12) Patent Application Publication
(10) Pub. No.: US 2006/0079200 A1
(43) Pub. Date: Apr. 13, 2006

(54) Disaster system control method and disaster system control apparatus

(76) Inventors: Kiyoshi Hirouchi, Kawasaki (JP); Yayoi Itoh, Kawasaki (JP); Naoyuki Kakizaki, Kawasaki (JP); Saiki Kawamura, Kawasaki (JP); Satoru Abe, Kawasaki (JP); Yoshikazu Takeda, Kawasaki (JP); Takahito Suzuki, Kawasaki (JP); Hiroki Yokoyama, Kawasaki (JP)

Correspondence Address: KATTEN MUCHIN ROSENMAN LLP, 575 MADISON AVENUE, NEW YORK, NY, 10022-2585, US

(21) Appl. No.: 11/289,744

(22) Filed: Nov. 29, 2005

Related U.S. Application Data
(63) Continuation of application No. PCT/JP03/08546, filed on Jul. 4, 2003.

(51) Int. Cl. H04M 11/04

(52) U.S. Cl. 455/404.1; 455/521

(57) ABSTRACT

In a disaster system control method and apparatus transmitting disaster status information through a mobile communication network or a fixed communication network, in order to promptly transmit/receive disaster status information at a time of a disaster occurrence between a disaster monitoring person and afflicted people within a disaster occurrence area, a bandwidth control apparatus assigns a bandwidth for a packet call in preference to other calls, a mobile terminal installs an application for disaster thereon for transmitting/receiving disaster status information between a disaster system center and the mobile terminal itself, and the disaster system center provides the mobile terminal within a disaster occurrence area with an application for disaster startup mail to start up the application for disaster.

### CROSS-REFERENCE TO RELATED APPLICATION

This application is a continuation of International Application PCT/JP03/08546 filed on Jul. 4, 2003, the contents of which are herein wholly incorporated by reference.

### BACKGROUND OF THE INVENTION

1. Field of the Invention

The present invention relates to a disaster system control method and a disaster system control apparatus, and in particular to a disaster system control method and a disaster system control apparatus transmitting disaster information through a mobile communication network or a fixed communication network.

Together with a recent sophisticated development in communication technologies, not only in the mobile communication network but also the fixed communication network, communication means have increased their operating speed, have been multimedialized, and have become more and more important as means for exchanging information. When a large-scale disaster such as an extensive earthquake and fire occurs, there is a possibility in the communication means that calling becomes difficult and important data such as disaster information/affliction information (information related to a disaster-stricken state) is delayed or discarded because of congestion of an exchange network due to increases of calls and data communication between an afflicted area and a periphery of the afflicted area. Accordingly, it is important to take measures against such congestion and discard.

2. Description of the Related Art

As a prior art disaster system control apparatus, the following items (1)-(5) can be mentioned.
(1) There is an apparatus in which an operator in a communication management center monitors congestion occurrence statuses, and actuates a restriction of communication lines upon congestions, when a large disaster occurs, and congestions of communication lines instantaneously occur due to calls for confirming the safety of people within an afflicted area from people outside the afflicted area, and rescue request calls or the like by afflicted people requesting required aids.
(2) There is an apparatus for rendering emergency messaging services in which afflicted people dial a certain telephone number to leave messages of information about their safety so that people outside the afflicted area may listen to the messages.
(3) A disaster system control apparatus acquiring disaster information by using a mobile application of a mobile terminal (mobile phone) with the Global Positioning System (GPS) function has been researched/developed. In this disaster system control apparatus, a municipality staff preliminarily downloads inputting software of a disaster status to a mobile terminal, visits a disaster area upon disaster occurrence, and inputs the disaster status to the mobile terminal, thereby collecting the disaster information.
(4) A PHS mobile terminal is provided with a disaster notifying means for notifying disaster information. The disaster information is transmitted to an information collecting/processing means for collecting the disaster information from the PHS mobile terminal through an exchange station. The information collecting/processing means can collect the disaster information by calling the PHS mobile terminal. Also, a PHS base station can prohibit calls of the PHS mobile terminals other than calls made by signals from the exchange station.

Furthermore, the information collecting/processing means records messages of the PHS mobile terminals which have notified the disaster information per PHS base station having received the message, and grasps disaster occurrence statuses from data recorded (see e.g. patent document 1).
(5) Communication terminal exchange facilities communicate with a mobile terminal within the area of a base station through the base station, and manage subscriber information of the mobile terminal. Center facilities communicate with the mobile terminal through the base station and the communication terminal exchange facilities, and registers information transmitted by the mobile terminal as transmitting information within the area of the base station. Also, the transmitting information within the range of the base station registered in the center facilities is retrieved and received by the mobile terminal.

Communication terminal exchange facilities are provided with a transmitting information registering means, an information transmitting means, and a used information registering means. The transmitting information registering means recognizes the transmission from the mobile terminal and transmits the transmission to the center facilities. The information transmitting means retrieves registered information and requests the center facilities to transmit the retrieved information, and the used information registering means recognizes the transmission from the mobile terminal and stores the transmission in a subscriber database.

The center facilities are provided with the transmitting information registering means and the information transmitting means. The transmitting information registering means transmits information required for transmission to the mobile terminal, registers the registered information from the mobile terminal in a registering database, and the information transmitting means receives an information transmitting request from the communication terminal exchange facilities and transmits the registered information (see e.g. patent document 2).

<Patent Document 1>

Japanese Patent Application Laid-open No.10-40484

<Patent Document 2>

Japanese Patent Application Laid-open No.2000-201377

The above-mentioned disaster system control apparatuses (1)-(5) respectively have the following problems.

As for the restriction of the communication lines in the disaster system control apparatus (1), all of the calls are to be restrained regardless of emergency. When a person who desires to grasp a disaster status collects much information, a communication method by a mobile terminal is effective and he or she tries to collect the information by the method. However, under the communication line restrained status, information discard, delay, or the like occurs, so that a difficulty of information collection is anticipated.

In the disaster system control apparatus (2), by the disaster message dial service of a safety confirming means, the function can not be effected until an afflicted person leaves a message. Also, since a recording time is limited to several seconds in an emergency messaging service, it is very difficult for the afflicted person to input information by which a detailed status as to whether the afflicted person is seriously/slightly injured or the like can be recognized.

In the disaster system control apparatus (3), since it is required for the municipality staff to visit a disaster site, it takes time to collect the disaster information.

As a call restrained in the disaster system control apparatus (4), two modes of a “normal mode” and a “disaster mode” can be mentioned. It is possible to transmit/receive calls of only a mobile terminal of the “disaster mode” upon disaster occurrence, so that a mobile terminal of the “normal mode” or a mobile terminal not included in the disaster system, i.e. without disaster notifying means can not transmit/receive. Also, only data (disaster information) preliminarily recorded in a disaster code recording portion of the mobile terminal can be notified to the information collecting/processing means. Also, in order to accommodate to the disaster system control apparatus (4), the mobile terminal must be provided with a storing portion and a disaster code storing portion.

In the disaster system control apparatus (5), it is required for the communication terminal exchange facilities to have the transmitting information registering means, the user information registering means, and the information transmitting means. Also, information concerning this system is necessary for a “subscriber information database” required for an exchange operation, which influences a conventional exchange operation. Also, since a restraint on communication lines giving a preference to an emergency communication upon disaster occurrence is not made, there is a possibility of disabling an emergency communication due to congestion.

### SUMMARY OF THE INVENTION

It is accordingly an object of the present invention to provide a disaster system control method and apparatus transmitting disaster information through a mobile communication network or a fixed communication network, wherein disaster status information at a time of a disaster occurrence is promptly transmitted/received between a disaster monitoring person and afflicted people within a disaster occurrence area.

In order to achieve the above-mentioned object, a disaster system control method according to the present invention comprises: a first step at which a disaster system center provides a bandwidth control apparatus with a disaster occurrence instruction signal; and a second step at which the bandwidth control apparatus assigns a bandwidth for a packet call in preference to other calls.

Namely, when a disaster has occurred, e.g. a disaster system center provides a bandwidth control apparatus with a disaster occurrence instruction signal. The bandwidth control apparatus having received this signal assigns a bandwidth for a packet call in preference to e.g. a voice call.

Thus, it becomes possible to preferentially transfer packet calls which can transmit more information than voice calls or the like. By performing a transmission/reception between the disaster system center and e.g. a mobile terminal within a disaster occurrence area by the packet calls, an information collection route can be secured, and a call congestion state upon disaster can be reduced. Namely, it becomes possible to promptly transmit/receive disaster status or situation information upon disaster occurrence between the disaster monitoring person and the afflicted people within the disaster occurrence area.

Also, in the present invention according to the above-mentioned present invention, the disaster system control method may further comprise a third step at which the disaster system center determines a terminal within a disaster occurrence area based on terminal position information, and a fourth step at which the disaster system center gives urgent notice by mail to the determined terminal, indicating that a disaster has occurred.

Namely, the disaster system center determines a terminal within a disaster occurrence area based on terminal position information, e.g. when the terminal is a user equipment (or mobile terminal), terminal position information of a home location register. To the determined terminal, the disaster system center notifies that a disaster has occurred in an area where the terminal is located, by an urgent notice mail.

Thus, it becomes possible to give urgent notice informing that the disaster has occurred to each terminal within the disaster occurrence area by mail.

Also, in the present invention according to the above-mentioned present invention, the disaster system control method may further comprise a third step at which the disaster system center determines a terminal within a disaster occurrence area based on terminal position information, and a fourth step at which the disaster system center provides a terminal installing thereon an application for disaster for transmitting/receiving disaster status information at a time of a disaster occurrence with a startup mail for the application for disaster.

Namely, a terminal installs thereon an application for disaster (program for disaster) for transmitting/receiving (exchanging) disaster status information. The disaster system center determines a terminal within the disaster occurrence area based on terminal position information at a time of a disaster occurrence, and transmits a startup mail to the terminal to start up the application for disaster. The application for disaster is prepared so as to accurately transmit/receive the disaster status information.

Thus, it becomes possible to transmit/receive the disaster status information using the application for disaster between the disaster system center and the terminal (subscriber).

Also, it becomes possible for the disaster system center to grasp a detailed disaster status per disaster area (e.g. per cell, RNC, node B in case of a mobile network), or per afflicted person by analyzing the disaster status information.

Also, it becomes possible for an indefinite number of terminal subscribers in the vicinity of the disaster occurrence area to request the provision of the disaster status information. Also, by periodically transmitting/receiving the disaster status information, the latest disaster status information can be transmitted/received between the disaster monitoring person and the afflicted person.

Furthermore, in the transmission/reception of the disaster status information, by setting inquiries to the subscribers variable, accurate information corresponding to the disaster can be acquired.

Also, as for data acquired from the terminal (subscriber) by the disaster system center, e.g. the following (1)-(5) can be mentioned: (1) disaster status data obtained by subscribers' responding to inquiries from the application for disaster, (2) text information of a comment such as a disaster status or the like freely inputted by the subscribers, (3) image data of a surrounding disaster status or the like taken by the subscribers, (4) moving image data of the surrounding disaster status or subscribers' disaster status or the like taken by the subscribers, and (5) voice data describing the disaster status or the like by the subscribers' voice.

Also, in the present invention according to the above-mentioned present invention, the disaster system control method may further comprise a fifth step at which the disaster system center provides the bandwidth control apparatus with a correction signal of a preferential assignment of the bandwidth for the packet call based on the disaster status information, and a sixth step at which the bandwidth control apparatus corrects an assignment of giving a preference to the bandwidth for the packet call based on the correction signal.

Namely, the disaster system center grasps an affliction status based on the disaster status information transmitted/received to/from the terminals within the disaster occurrence area, provides the bandwidth control apparatus with a correction signal of a preferential assignment of the bandwidth for the packet call based on the disaster status information, e.g. the number of afflicted subscribers, and the bandwidth control apparatus corrects an assignment of giving a preference to the bandwidth for the packet call based on the correction signal.

Thus, it becomes possible to perform the preferential assignment of the bandwidth for the packet call according to the affliction status

Furthermore, in the present invention according to the above-mentioned present invention, the third step may provide a home location register with the disaster occurrence area to acquire a terminal number within the area, and may provide a mail server with the acquired terminal number to acquire a mail address corresponding to the terminal number.

Thus, it becomes possible to recognize mail addresses of the terminals within the disaster occurrence area.

Also, in order to achieve the above-mentioned object, a disaster system control apparatus according to the present invention comprises: a disaster system center outputting a disaster occurrence instruction signal instructing to assign a bandwidth for a packet call in preference to other calls when a disaster occurrence signal is received; and a bandwidth control apparatus receiving the disaster occurrence instruction signal and preferentially assigning the bandwidth for the packet call.

Thus, it becomes possible to preferentially transfer the packet calls which can transmit more information than e.g. the voice calls, to reduce a call congestion state at the time of the disaster, and to promptly transmit/receive the disaster status information by using the packet calls between the disaster monitoring person and the afflicted people within the disaster occurrence area.

Also, in the present invention according to the above-mentioned present invention, the disaster system center may give urgent notice, by mail, indicating that a disaster has occurred to a terminal within a disaster occurrence area determined based on terminal position information.

Thus, it becomes possible to give urgent notice informing a disaster occurrence by mail to a terminal within a disaster occurrence area.

Also, in the present invention according to the above-mentioned present invention, the disaster system control apparatus may further comprise a terminal installing thereon an application for disaster for transmitting/receiving disaster status information between the disaster system center and the apparatus itself; and the disaster system center may determine a terminal within a disaster occurrence area based on terminal position information, and may provide the terminal with a startup mail of the application for disaster at a time of a disaster occurrence.

Thus, it becomes possible to transmit/receive the disaster status information using the application for disaster between the disaster system center and the terminal.

Also, in the present invention according to the above-mentioned present invention, the disaster system center may provide the bandwidth control apparatus with a correction signal of a preferential assignment of the bandwidth for the packet call based on the disaster status information, and the bandwidth control apparatus may correct the preferential assignment of the bandwidth for the packet call based on the correction signal.

Thus, it becomes possible to perform a preferential assignment of the bandwidth for the packet call according to the disaster status.

Furthermore, in the present invention according to the above-mentioned present invention, the disaster system center may provide a home location register with the disaster occurrence area to acquire a terminal number within the area, and may provide a mail server with the acquired terminal number to acquire a mail address corresponding to the terminal number.

Thus, it becomes possible to recognize mail addresses of the terminals within the disaster occurrence area.

Also, in order to achieve the above-mentioned object, a bandwidth control apparatus according to the present invention comprises: a disaster occurrence instructing portion inputting a disaster occurrence signal; and a bandwidth controller assigning a bandwidth for a packet call in preference to other calls when the disaster occurrence instructing portion receives the disaster occurrence signal.

Namely, a disaster occurrence signal is inputted to a disaster occurrence instructing portion. At this time, the bandwidth controller gives a preference to e.g. the bandwidth for the packet call over the voice call.

Thus, it becomes possible to preferentially transfer the packet calls which can transmit more information than the voice calls, to reduce a call congestion state at the time of the disaster, and to promptly transmit/receive the disaster status information at the time of the disaster occurrence between the disaster monitoring person and the afflicted people within the disaster occurrence area.

It is to be noted that the disaster occurrence signal may be manually inputted to the disaster occurrence instructing portion e.g. by a determination of an operator of the bandwidth control apparatus itself, or may be automatically inputted from e.g. an external disaster system center or the like. Also, as for the bandwidth control apparatus, a radio control apparatus of e.g. a radio access network can be mentioned.

Also, in the present invention according to the above-mentioned present invention, the bandwidth controller may preferentially assign a preset bandwidth to the packet calls, or may correct the bandwidth for the packet call according to a disaster scale.

Namely, the disaster occurrence instructing portion can preferentially assign a preset bandwidth to the packet calls e.g. at an initial state of the disaster occurrence when the disaster scale is not recognized, and can correct the packet call bandwidth according to the disaster scale, e.g. the number of afflicted people when e.g. the disaster scale is recognized.

Also, in order to achieve the above-mentioned object, a disaster system center according to the present invention comprises: a disaster occurrence instructing portion inputting a disaster occurrence signal; and a disaster bandwidth controller outputting a disaster occurrence signal instructing to assign a bandwidth for a packet call in preference to other calls when the disaster occurrence instructing portion receives the disaster occurrence signal.

Namely, an operator of e.g. the disaster system center inputs a disaster occurrence signal instructing the disaster occurrence by its own determination to the disaster occurrence instructing portion. At this time, the disaster bandwidth controller transmits the disaster occurrence instructions to e.g. an external bandwidth control apparatus (radio control apparatus of radio access network). The bandwidth control apparatus performs the disaster bandwidth control giving a preference to the bandwidth for the packet call over e.g. the voice call.

Thus, it becomes possible to give a preference to the packet calls which can transmit more information than the voice calls, to reduce a congestion state at the time of the disaster, and to promptly transmit/receive the disaster status information at the time of the disaster occurrence between the disaster monitoring person and the afflicted people within the disaster occurrence area.

Also, in order to achieve the above-mentioned object, a disaster system center according to the present invention comprises: a disaster system main controller determining a terminal within a disaster occurrence area based on position information of the terminal; and an urgent notifying processor giving urgent notice, to the terminal within the area, indicating that a disaster has occurred.

Namely, when a terminal is e.g. a user equipment, a disaster system main controller determines whether or not the terminal is located in the disaster occurrence area based on position information from a home location register or position information from the GPS or the like. Also when the terminal is a fixed terminal, whether or not the terminal is located in the disaster occurrence area is determined based on the information of the position where the fixed terminal is set, e.g. a prepared table of fixed terminal No.-address. An urgent notifying processor gives urgent notice indicating that the disaster has occurred to the terminal located in the disaster occurrence area.

Thus, it becomes possible to give the urgent notice to the terminal within the disaster occurrence area.

Also, in the present invention according to the above-mentioned invention, the disaster system center may further comprise: an information acquiring portion requesting a terminal number within the disaster occurrence area from a home location register, requesting a mail address corresponding to the terminal number by providing a mail server with the terminal number acquired in response to the request, and providing the disaster system main controller with the acquired mail address; and the urgent notifying processor may give the urgent notice to the mail address.

Namely, when the terminal is a user equipment, an information acquiring portion transmits to a home location register a terminal No. request within the disaster occurrence area to which a radio base station No. is designated as e.g. the disaster occurrence area and acquires the terminal No. as a response. Furthermore, the information acquiring portion provides a mail server with the acquired terminal No., requests mail address corresponding to the terminal No., acquires the mail address, and provides the mail address to the disaster system main controller.

The urgent notifying processor transmits an urgent notice mail to the mail address of the terminal determined by the disaster system main controller.

Thus, it becomes possible to give urgent notice by mail to the terminal within the disaster occurrence area.

Also, in the present invention according to the above-mentioned present invention, a disaster system main controller may determine a terminal installing thereon an application for disaster for transmitting/receiving disaster status information within a disaster occurrence area based on position information of the terminal, and the urgent notifying processor may start up the application for disaster by transmitting an urgent notice mail for starting up the application for disaster to the terminal at a time of a disaster occurrence and may transmit/receive the disaster status information.

Namely, the terminal installs thereon the application for disaster for transmitting/receiving the disaster status information. The disaster system main controller determines the terminal within the disaster occurrence area based on the position information of the terminal. The urgent notifying processor transmits the urgent notice mail for starting up the application for disaster to the terminal within the disaster occurrence area at the time of the disaster occurrence to start up the application for disaster.

Thus, it becomes possible to promptly transmit/receive the disaster status information at the time of the disaster occurrence between the disaster monitoring person and the afflicted people within the disaster occurrence area.

Also, in the present invention according to the above-mentioned present invention, the disaster system main controller may compile the disaster status information into a database to be analyzed, and the disaster bandwidth controller may transmit a bandwidth correction control signal instructing to assign a bandwidth for a packet call in preference to other calls based on an analysis result.

Namely, the disaster system main controller compiles the disaster status information into a database to be analyzed. The disaster bandwidth controller transmits to the outside thereof a bandwidth correction control signal instructing an assignment of the bandwidth for the packet call in preference to the voice calls based on an analysis result, e.g. the number of afflicted subscribers.

The bandwidth control apparatus (radio control apparatus) having received this signal, for example, performs the bandwidth control based on a bandwidth correction control signal. Thus, it becomes possible to assign the bandwidth according to the disaster status, e.g. the disaster scale.

Also, in the present invention according to the above-mentioned present invention, the disaster system main controller may classify disasters, based on a disaster identifier which identifies a plurality of disasters to be analyzed.

Thus, it becomes possible to identify a plurality of disasters having occurred and to analyze them per disaster. It is to be noted that the same disaster may be analyzed them in more detail by classifying the same disaster more minutely by using a plurality of disaster identifiers for the same disaster.

Also, in the present invention according to the above-mentioned present invention, the disaster system main controller may analyze the disaster status information per disaster area and per terminal.

Thus, it becomes possible to perform a rescue operation by giving a preference to e.g. an area or a terminal, e.g. according to an affliction status.

Furthermore, in the present invention according to the above-mentioned present invention, the urgent notifying processor may transmit the analysis result to a terminal within a disaster occurrence area.

Thus, it becomes possible for the terminal to grasp the disaster status.

Also, in order to achieve the above-mentioned object, a disaster system center according to the present invention comprises: a preregistered information database preliminarily holding an identifier of a terminal installing thereon an application for disaster which transmits/receives disaster status information; a disaster system main controller determining a terminal within a disaster occurrence area based on position information of a terminal; and an urgent notifying processor outputting a download request requesting a download of an application for disaster to a terminal within the disaster occurrence area installing thereon no application for disaster.

Namely, a preregistered information database holds an identifier of a terminal installing thereon an application for disaster. A disaster system main controller determines a terminal within the disaster occurrence area based on position information of a terminal. An urgent notifying processor outputs a download request requesting a download of an application for disaster to a terminal within the disaster occurrence area installing thereon no application for disaster.

Thus, it becomes possible to install the application for disaster on the terminal which has not installed the application for disaster, and to transmit/receive the disaster status information or the like by using the application for disaster.

Also, in the present invention according to the above-mentioned present invention, the urgent notifying processor may compulsorily download the application for disaster to the terminal within the disaster occurrence area.

Thus, it becomes possible to compulsorily download the application for disaster to the terminal which does not download the application for disaster in spite of the transmission of the download request thereof.

Furthermore, in the present invention according to the above-mentioned present invention, the urgent notifying processor may output an application startup request for disaster requesting a startup of the application for disaster which the terminal within the disaster occurrence area installs thereon.

Namely, the urgent notifying processor can start up the application for disaster downloaded to the terminal within the disaster occurrence area.

Also, in order to achieve the above-mentioned object, a terminal according to the present invention comprises: a transceiver receiving an application startup request for disaster at a time of a disaster occurrence; and an application for disaster transmitting/receiving disaster status information started up when the transceiver receives the startup request.

Namely, a transceiver receives an application startup request for disaster, and starts up the application for disaster. The application for disaster transmits/receives the disaster status information to/from e.g. the disaster system center.

Thus, it becomes possible to promptly transmit/receive the disaster status information at the time of the disaster occurrence between the disaster monitoring person (disaster system center) and the afflicted people within the disaster occurrence area. It is to be noted that as a terminal, a fixed terminal, a mobile terminal, a user equipment, or the like can be mentioned.

Also, in the present invention according to the above-mentioned present invention, the disaster status information may comprise any one of disaster status data responded by subscribers to inquiries from an application for disaster, text information of a comment on disaster statuses freely inputted by subscribers, image data of surrounding disaster statuses taken by subscribers, moving image data of surrounding disaster statuses or disaster statuses of subscribers themselves taken by the subscribers, and voice data describing disaster statuses by voice of subscribers.

Thus, it becomes possible to transmit the affliction status in various kinds of information form, and to transmit in more detail the affliction status.

Furthermore, in the present invention according to the above-mentioned present invention, the application for disaster may be started up only when the application startup request for disaster includes an urgent code.

Thus, it becomes possible to prevent the startup of the application for disaster by a malicious startup request.

Furthermore, in order to achieve the above-mentioned object, a terminal according to the present invention comprises: a transceiver receiving a download request requesting a download of an application for disaster; and an application management portion downloading an application for disaster when the transceiver receives the download request.

Namely, when the terminal has not installed thereon the application for disaster, and when the transceiver receives a download request, an application management portion downloads the application for disaster. Thus, it becomes possible for the terminal to transmit/receive the disaster status by using the application for disaster at the time of the disaster occurrence.

Also, in the present invention according to the above-mentioned present invention, the application management portion may download an application for disaster only when an urgent code identifier is included in the download request.

Thus, it becomes possible to prevent the download of the application for disaster by a malicious download request.

### BRIEF DESCRIPTION OF THE DRAWINGS

The above and other objects and advantages of the invention will be apparent upon consideration of the following detailed description, taken in conjunction with the accompanying drawings, in which the reference numerals refer to like parts throughout and in which:

FIG. 1 is a block diagram showing an embodiment of a disaster system control apparatus according to the present invention;

FIG. 2 is a block diagram showing a disaster occurrence state example and a located-in-area example of a user equipment in a disaster system control apparatus according to the present invention;

FIG. 3 is a flowchart showing an overall processing procedure example of a disaster system control apparatus according to the present invention;

FIG. 4 is a flowchart showing in more detail a processing procedure example of a disaster system control apparatus according to the present invention;

FIG. 5 is a block diagram showing an embodiment of a disaster system center, a radio control apparatus, a user equipment, and the like in a disaster system control apparatus according to the present invention;

FIG. 6 is a block diagram showing an example of an application execution environment in a user equipment of a disaster system control apparatus according to the present invention;

FIG. 7 is a sequence diagram showing in more detail an operation procedure example (No.1) of a disaster system control apparatus according to the present invention;

FIG. 8 is a sequence diagram showing in more detail an operation procedure example (No.2) of a disaster system control apparatus according to the present invention;

FIG. 9 is a flowchart showing an operation procedure example of securement of a bandwidth for disaster in a bandwidth control apparatus in a disaster system control apparatus according to the present invention;

FIG. 10 is a flowchart showing an operation procedure example of securement of a bandwidth for disaster in an interface Iub of a disaster system control apparatus according to the present invention;

FIGS. 11A and 11B are diagrams showing an example of securement of a bandwidth for disaster in an interface Iub of a disaster system control apparatus according to the present invention;

FIG. 12 is a flowchart showing an operation procedure example of securement of a bandwidth for disaster in an interface Iu of a disaster system control apparatus according to the present invention;

FIGS. 13A and 13B are diagrams showing an example of securement of a bandwidth for disaster in an interface Iu of a disaster system control apparatus according to the present invention;

FIG. 14 is a sequence diagram showing an operation procedure example of a subscriber information acquisition in a disaster system control apparatus according to the present invention;

FIG. 15 is a sequence diagram showing an operation procedure example (No.1) of an application for disaster in a user equipment of a disaster system control apparatus according to the present invention;

FIG. 16 is a diagram showing an example of an application startup mail for disaster transmitted by a disaster system center of a disaster system control apparatus according to the present invention;

FIG. 17 is a sequence diagram showing an operation procedure example (No.2) of an application for disaster in a user equipment of a disaster system control apparatus according to the present invention;

FIGS. 18A and 18B are block diagrams showing a disaster system database example and a preparation example thereof in a disaster system center of a disaster system control apparatus according to the present invention;

FIG. 19 is a flowchart showing an analysis processing example of disaster information in a disaster system center of a disaster system control apparatus according to the present invention;

FIG. 20 is a flowchart showing an analysis processing example of disaster status information in a case where a plurality of disasters have occurred simultaneously, in a disaster system center of a disaster system control apparatus according to the present invention;

FIG. 21 is a flowchart showing a transmission processing example of an application download request mail for disaster in a disaster system center of a disaster system control apparatus according to the present invention;

FIG. 22 is a diagram showing an example of an application download request mail for disaster transmitted by a disaster system center of a disaster system control apparatus according to the present invention;

FIG. 23 is a flowchart showing a startup processing example of an application for disaster by a mail in a user equipment of a disaster system control apparatus according to the present invention;

FIG. 24 is a flowchart showing an urgent startup processing example of an application for disaster by a mail in a user equipment of a disaster system control apparatus according to the present invention; and

FIG. 25 is a diagram showing an urgent startup mail example of an application for disaster transmitted by a disaster system center of a disaster system control apparatus according to the present invention.

### DESCRIPTION OF THE EMBODIMENTS

<Overall Arrangement>

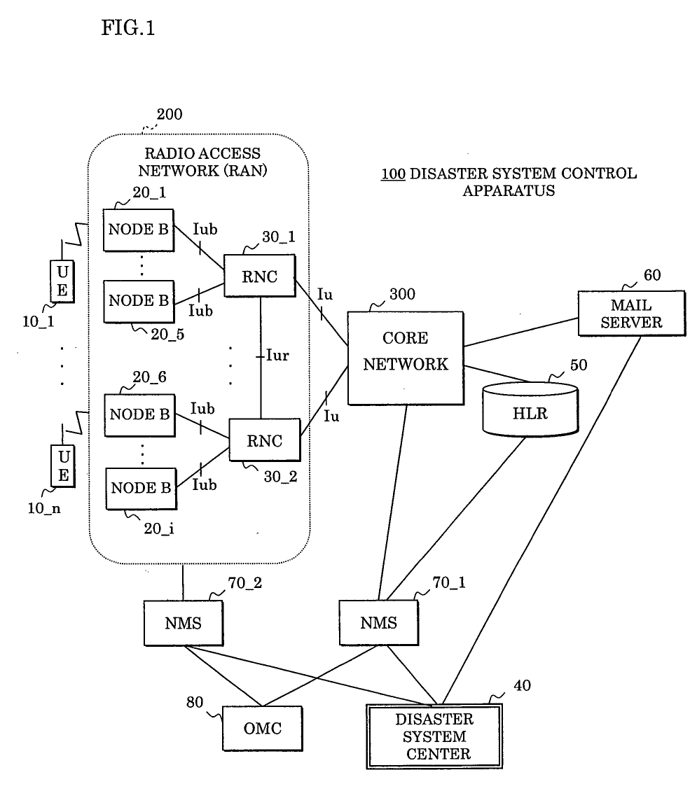

FIG. 1 shows an embodiment of a disaster system control apparatus 100 which is one embodiment of a disaster system control method according to the present invention. This disaster system control apparatus 100 is composed of a disaster system center (hereinafter, occasionally abbreviated as DS) 40, a home location register (hereinafter, occasionally abbreviated as HLR) 50, a mail server 60, a core network 300, a radio access network (hereinafter, occasionally abbreviated as RAN) 200, and user equipments (hereinafter, occasionally abbreviated as UE) or mobile stations 10_1-10_n (hereinafter, occasionally represented by a reference numeral 10).

The RAN 200 is provided with radio network controllers (hereinafter, occasionally abbreviated as RNC) 30_1 and 30_2 (hereinafter, occasionally represented by a reference numeral 30), and nodes B20_1-B20_i (hereinafter, occasionally represented by a reference numeral 20). This node B20 is a logical node performing a radio transmission/reception, and is specifically a radio base station. Also, the system control apparatus 100 is provided with an OMC 80 and NMSs 70_1 and 70_2.

The core network 300 is connected to the RNC 30 with an interface Iu, the RNCs 30 are connected with an interface Iur, and the RNC 30 is connected to the node B20 with an interface Iub. Also, the UE 10 is connected to the node B20 with a radio line.

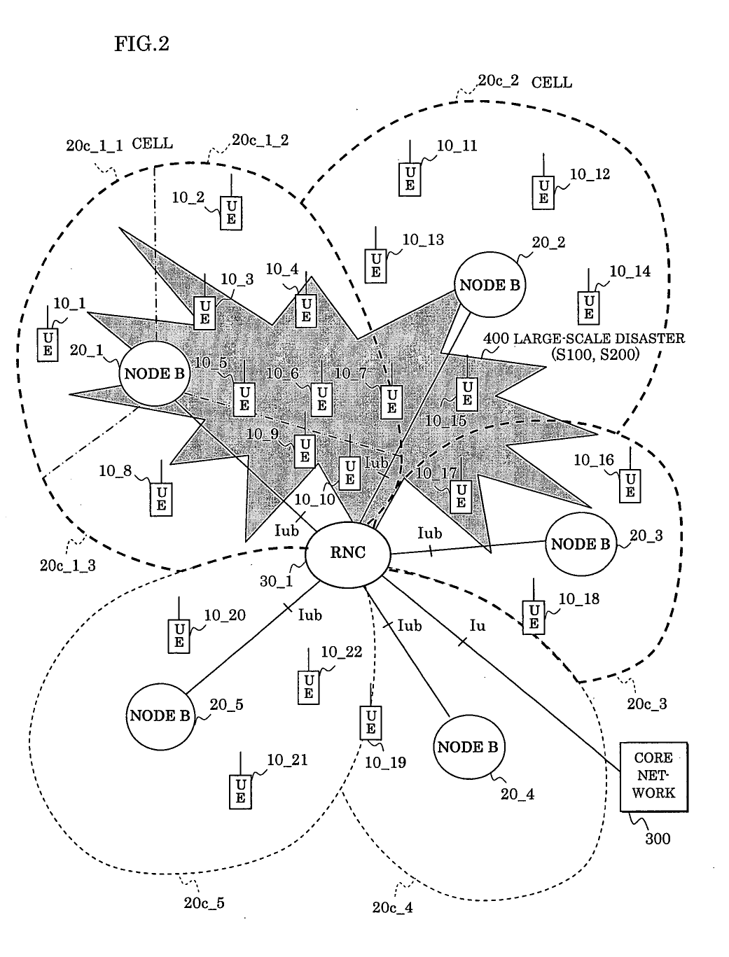

FIG. 2 shows in more detail the radio access network 200 shown in FIG. 1, where the network 200 is composed of the RNC 30_1 and the nodes B20_1-20_5 connected to the RNC 30_1.

The node B20 covers a single or a plurality of cells. The node B20 is sectored by using a plurality of directional antennas, each sector being called a cell. The node B20_1 is sectored, covers cells 20c_1_1-20c_1_3, while the nodes B20_2-B20_5 are not sectored and respectively cover cells 20c_2-20c_5.

In the areas of the cells 20c_1_1-20c_1_3, and 20c_2-20c_5, UEs 10_1, 10_2-10_7, 10_8-10_10, 10_11-10_15, 10_16-10_18, 10_19, and 10_20-10_22 are respectively located.

The disaster system control apparatus 100 at large performs processings (1)-(5) as follows:

(1) Actuation of bandwidth restriction and bandwidth change for disaster; (2) Urgent notice processing to all user equipments located in a disaster area; (3) Acquisition processing of disaster status information in each user equipment; (4) Analysis processing of disaster status information database; and (5) Bandwidth correction for disaster.

<Overall Processing Flow>

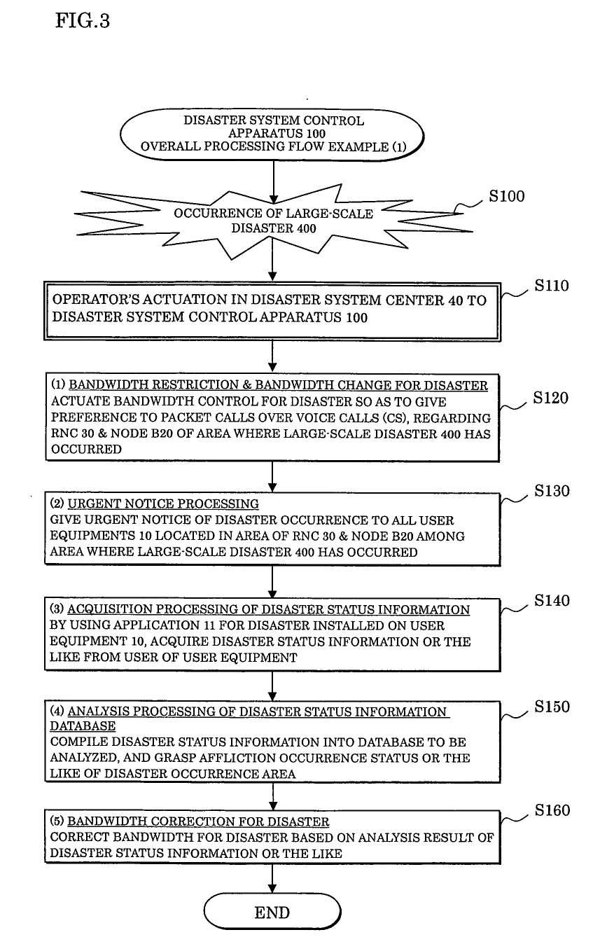

FIG. 3 shows an overall processing flow example (1) of the disaster system control apparatus 100. This flow example (1) shows a case where a large-scale disaster 400 (see FIG. 2) has occurred within the area of the cells 20c_1_1-20c_1_3, 20c_2, and 20c_3. This overall processing flow example (1) will now be described.

Step S100: A large-scale disaster 400 occurs.

Steps S110 and S120 (bandwidth restriction and bandwidth change for disaster): An operator in the disaster system center 40 starts (actuates) the operation of the disaster system control apparatus 100. Namely, the operator designates the RNC 30_1 and the nodes B20_1-20_3 of the area (see FIG. 2) where the large-scale disaster 400 has occurred, and starts the bandwidth control for disaster giving a preference to packet calls (PS calls) for data communication over voice calls (CS calls) in the RNC 30_1 and the nodes B20_1-20_3.

Thus, since the packet calls can treat more information than the voice calls, by transmitting/receiving disaster information by the packet calls to which a preference is given between the afflicted subscribers and the disaster system control apparatus 100, the disaster information becomes not easily delayed and discarded.

Step S130 (urgent notice processing to all of the user equipments within the disaster area): The disaster system center 40 gives urgent notice of the occurrence of the large-scale disaster 400 to all of the UEs 10_1-10_18 located in the cells 20c_1_1-20c_1_3, 20c 2, and 20c_3 of the nodes B20_1-B20_3 within the area where the large-scale disaster 400 has occurred. This urgent notice is used as a trigger when a subscriber of each UE 10 transmits his own affliction status information or the like to the disaster system center 40.

Step S140 (acquisition processing of disaster status information in each user equipment): The disaster system center 40 acquires the disaster status information or the like from a user of the user equipment by using an application 11 for disaster installed on the UE 10.

Namely, each UE 10 holds the application 11 for disaster preliminarily downloaded, which is started up by the urgent notice received. The subscriber of each user equipment 10 answers to the inquiries from the application 11 for disaster, and the answer content (disaster status information or the like) is transmitted to the disaster system center (DS) 40.

It is to be noted that an arrangement of preliminarily installing thereon the application 11 for disaster at the time of shipment of the user equipment 10 or of requiring the subscriber to surely download the application 11 after the purchase of the user equipment 10 when the disaster system control apparatus 100 of the present invention is adapted to all of the user equipments 10. However, it is supposed that the application 11 for disaster has been already downloaded to the user equipment in this description. It is to be noted that the processing of compulsorily downloading the application 11 for disaster will be described later.

Step S150 (analysis of disaster status information database): The disaster system center 40 compiles the disaster status information into the database, and analyzes e.g. the disaster status/afflicted people status or the like based on the database.

Step S160 (bandwidth correction for disaster): According to an analysis result of the disaster status information database, e.g. the number of afflicted subscribers of the afflicted object node B20, the PS call bandwidth for disaster is corrected. Namely, larger PS call bandwidth for disaster is secured when the number of afflicted subscribers is large, while the PS call bandwidth for disaster is reduced when the number of afflicted subscribers is small.

Thus, it becomes possible to perform the bandwidth control for disaster according to the affliction status, i.e. the number of subscribers in this description.

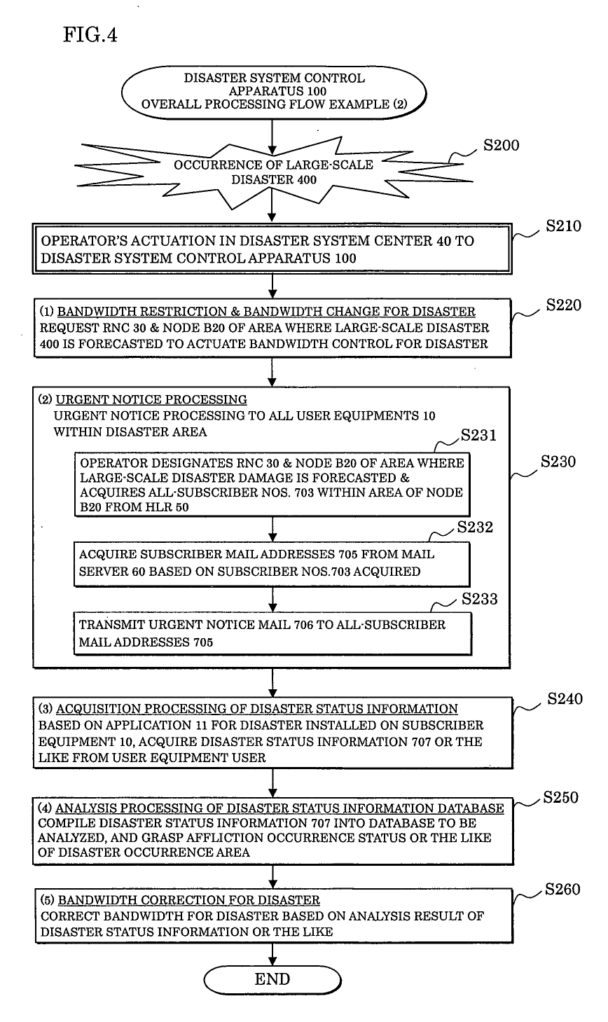

FIG. 4 shows an overall operation flow example (2) of the disaster system control apparatus 100 in the same way as FIG. 3. This flow example (2) specifically shows in more detail the urgent notice processing example to all of the UEs 10 located in the area. In this urgent notice processing example, an urgent notice is performed by specifically using a mail function. This operation flow example (2) will now be described.

Steps S200-S220: These steps are the same as steps S100-S120 of FIG. 3.

Step S230 (urgent notice processing): This step is the same as step S130 (urgent notice processing) of FIG. 3. However, at step S230, an urgent notice is performed by using the mail function.

Step S231: In the disaster system center 40, the operator designates the RNC 30 and the node B20 of the area where damage of the large-scale disaster 400 is forecasted, and acquires from the HLR 50 all-subscriber-in-area Nos.

Step S232: The disaster system center 40 designates the acquired subscriber Nos., and acquires the mail addresses of the subscribers from the mail server 60.

Step S233: The disaster system center 40 transmits urgent notice mails 706 to all of the mail addresses.

Steps S240-S250: These steps are the same as steps S140-S150 of FIG. 3.

Thus, it becomes possible to transmit the urgent notice mail to the mobile terminal 10 within the disaster occurrence area.

<Embodiment of Overall Arrangement>

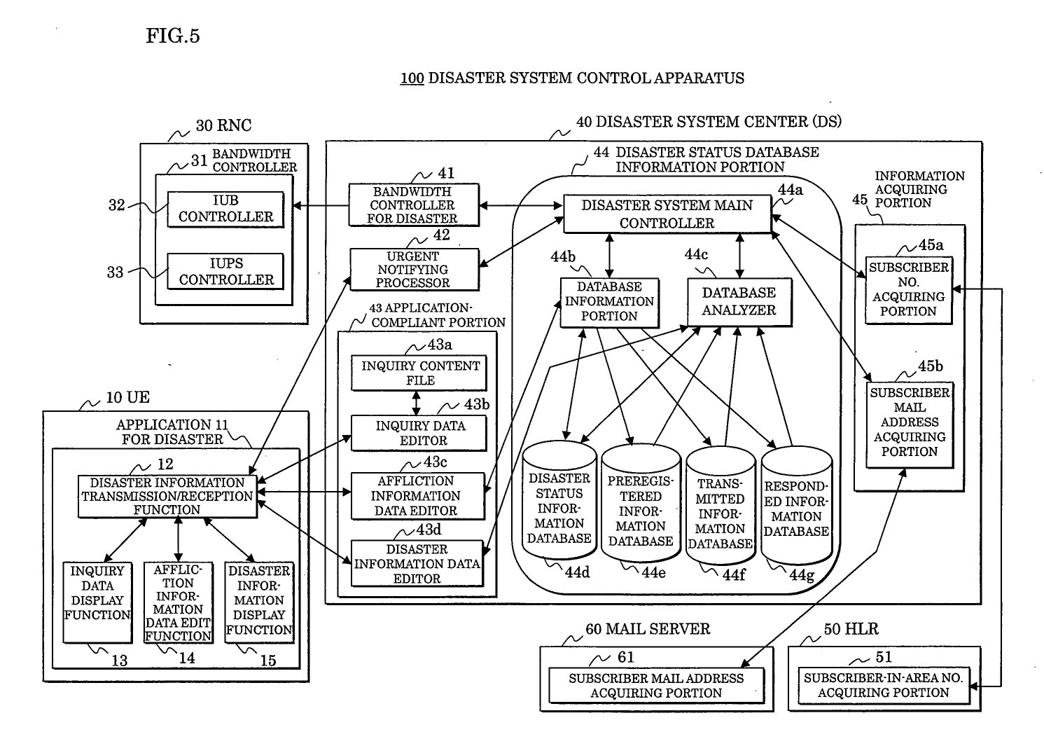

FIG. 5 shows an embodiment of the disaster system control apparatus 100, which is provided with, as shown in FIG. 1, the UE 10, the node B20 (not shown), the RNC 30, the disaster system center 40, the HLR 50, and the mail server 60.

The UE 10 is provided with the application 11 for disaster and an application management component 16 (not shown). The application 11 for disaster includes a disaster information transmission/reception function 12, an inquiry data display function 13, an affliction information data edit function 14, and a disaster information display function 15.

The RNC 30 is provided with a bandwidth controller 31, which includes an IUB controller 32 and an IUPS controller 33. The disaster system center 40 is provided with a bandwidth controller 41 for disaster, an urgent notifying processor 42, an application-compliant portion 43, a disaster status database information portion 44, and an information acquiring portion 45.

The application-compliant portion 43 includes an inquiry content file 43a, an inquiry data editor 43b, an affliction information data editor 43c, and a disaster information data editor 43d. The disaster status database information portion 44 is provided with a disaster system main controller 44a, a database information portion 44b, a database analyzer 44c, a disaster status information database 44d, a preregistered information database 44e, a transmitted information database 44f, and a responded information database 44g. The information acquiring portion 45 is provided with a subscriber No. acquiring portion 45a and a subscriber mail address acquiring portion 45b.

The HLR 50 is provided with a subscriber-in-area No. acquiring portion 51, and the mail server 60 is provided with a subscriber mail address acquiring portion 61.

Hereinafter, the operation of each functional portion of the above-mentioned (1) UE 10, (2) RNC 30, (3) disaster system center 40, (4) HLR 50, and (5) mail server 60 will be described.

(1) Application 11 for Disaster within UE 10

The disaster information transmission/reception function 12 performs a transmission/reception of the disaster status information between DS-UE, and the inquiry data display function 13 displays inquiry data. The affliction information data edit function 14 edits the data of the inputted affliction status or the like, and the disaster information display function 15 displays the disaster information. The application management component 16 manages application programs.

(2) RNC 30

The bandwidth controller 31 performs the bandwidth control for disaster regarding the concerned node B20. The IUB controller 32 performs an Iub bandwidth control for disaster, and the IUPS controller 33 performs an Iu-PS bandwidth control for disaster.

(3) Disaster System Center (DS) 40

(3a) The bandwidth controller 41 for disaster performs a start-up, a correction, a release, and the like of the bandwidth control for disaster of the bandwidth controller 31 in the RNC 30.

(3b) The urgent notifying processor 42 performs urgent notice processing (mail edit/transmission processing) to all of the mobile terminals located in the area.

(3c) Application-Compliant Portion 43

The inquiry content file 43a is a file storing inquiry contents for afflicted people. The inquiry data editor 43b edits/transmits inquiry data for a user. The affliction information data editor 43c edits the disaster status information transmitted from the user to be reflected in the database. The disaster information data editor 43d edits/transmits the disaster status information for the user.

(3d) Disaster Status Database Information Portion 44

The disaster system main controller 44a performs a relay control of each function block. The database information portion 44b compiles the disaster status information from the operator or the user into a database. The database analyzer 44c analyzes the disaster status information from the operator or the user. The disaster status information database 44d is a database holding results of analyzing the databases 44e, 44f, and 44g. The preregistered information database 44e is a database in which the subscribers are preregistered. The transmitted information database 44f is a database holding information transmitted to the terminal 10, and the responded information database 44g is a database holding information responded by the terminal 10 to the disaster system center 40.

(3e) Information Acquiring Portion 45

The subscriber No. acquiring portion 45a acquires, from an input RNC identifier/node B, all-subscriber-in-area Nos. It is to be noted that a plurality of nodes B20 are designatable. The subscriber mail address acquiring portion 45b acquires the subscriber mail address from the input subscriber No.

(4) HLR 50

The subscriber-in-area No. acquiring portion 51 retrieves all of the subscriber Nos. within the area from the input RNC identifier/node B (plurality of nodes B are designatable) to be acquired.

(5) Mail Server 60

The subscriber mail address acquiring portion 61 acquires the subscriber mail address from the input subscriber No.

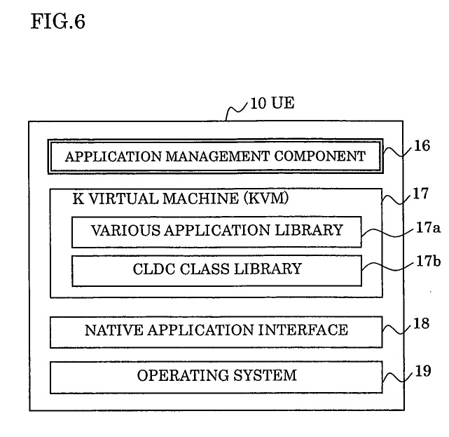

As shown in FIG. 6, the user equipment 10 is further provided with an application management component 16, a K virtual machine (KVM) 17, a native application interface 18, and an operating system 19. The K virtual machine (KVM) 17 includes a various application library 17a and a CLDC class library 17b.

The application management component 16 displays a list of applications installed on the mobile terminal 10, manages an execution of the application (e.g. startup, compulsory termination, application executed environment, intermediacy with other applications, or the like), installs applications or updates a version of the application, and deletes the application stored in the mobile terminal 10.

<Embodiment of Overall Processing Flow>

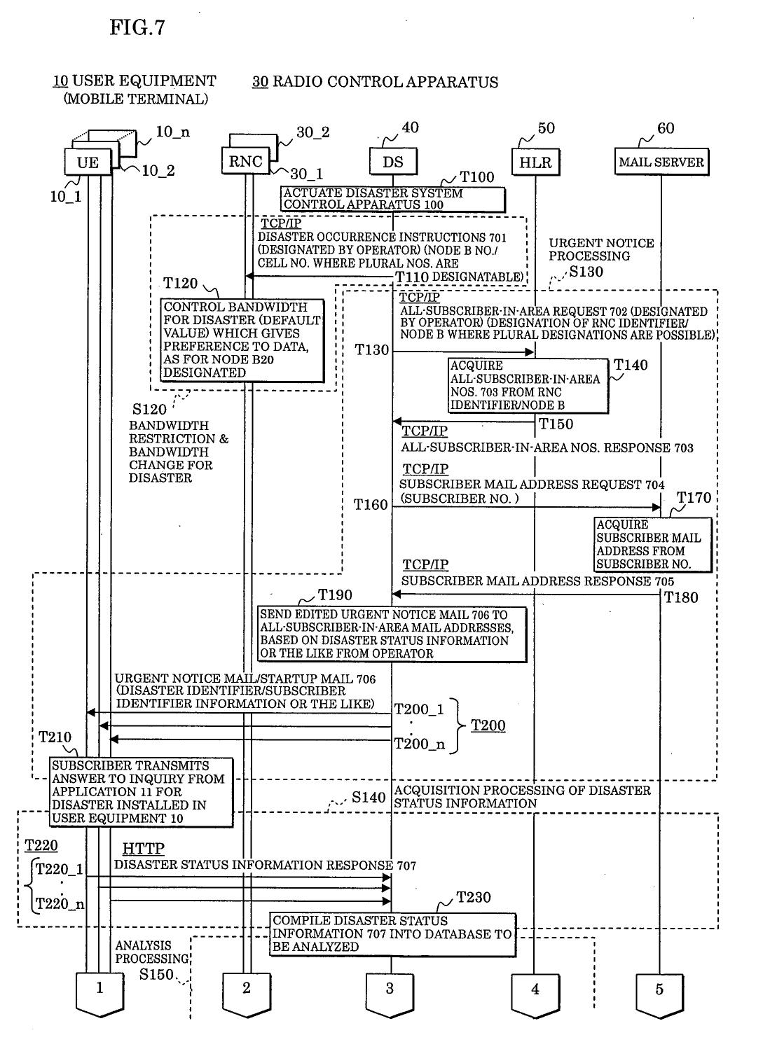

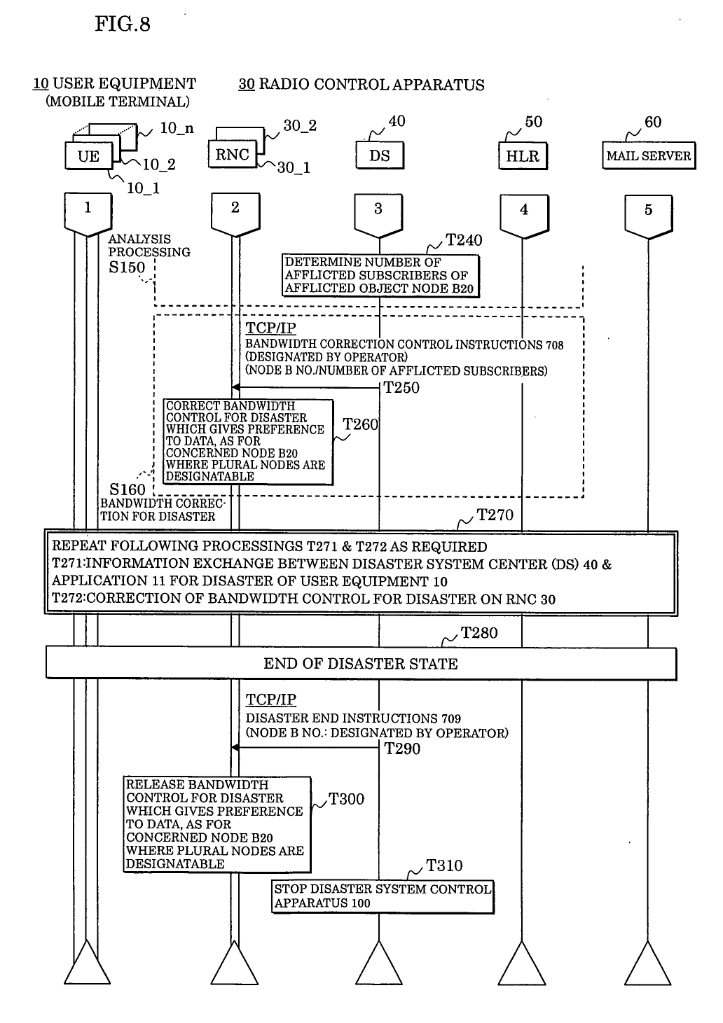

FIGS. 7 and 8 are operation procedure examples showing in more detail the overall processing flow example of the disaster system control apparatus 100 shown in FIG. 3. This operation procedure example will now be described by firstly referring to FIGS. 7 and 2.

Bandwidth Restriction and Bandwidth Change for Disaster

Step T100: The large-scale disaster 400 (see FIG. 2) occurs, whereby the disaster system control apparatus 100 is actuated.

Step T110: In the disaster system center (DS) 40, the operator provides, to the RNC 30 with TCP/IP protocol, disaster occurrence instructions 701 including identifiers (Nos.) of the nodes B20_{—}1-B20_{—}3 (hereinafter, occasionally represented by a reference numeral 20) where the disaster has occurred and identifiers (Nos.) of the cells 20c_{—}1_1-20c_1_3, 20c_2, and 20c_3 (hereinafter, occasionally represented by a reference numeral 20c). It is to be noted that a plurality of Nos. of the nodes B20 and the cells 20c are designatable as mentioned above.

Step T120: The RNC 30 controls the bandwidth for disaster to a preset default value giving a preference to the data communication (packet calls) regarding the nodes B20 and cells 20c of the designated Nos.

Urgent Notice Processing

Step T130: Furthermore, the operator provides, to the HLR 50 with TCP/IP protocol, the all-subscriber-in-area Nos. request 702 including the identifier of the RNC 30 and the No. of the node B, and inquires the all-subscriber Nos. within the area of the node B.

Steps T140 and T150: The HLR 50 retrieves the all-subscriber Nos. located in the area by the identifier of the RNC 30 and the No. of the node B20 designated, and provides an all-subscriber-in-area Nos. response 703 including the all-subscriber Nos. to the disaster system center 40 with TCP/IP protocol.

Step T160: The subscriber system center 40 transmits a subscriber mail address request 704 including the all-subscriber-in-area Nos. received to the mail server 60 with TCP/IP protocol.

Steps T170 and T180: The mail server 60 acquires the mail address of the subscriber of the subscriber-in-area No., and returns a subscriber mail address response 705 including the subscriber mail address to the disaster system center 40 with TCP/IP protocol.

Steps T190 and T200 1-T200 n (hereinafter, occasionally represented by a reference numeral T200): The disaster system center 40 transmits an urgent notice/startup mails 706_1-706_n (hereinafter, occasionally represented by a reference numeral 706) edited based on the disaster status information or the like from the operator to the all-subscriber-in-area mail addresses.

Acquisition Processing of Disaster Status Information

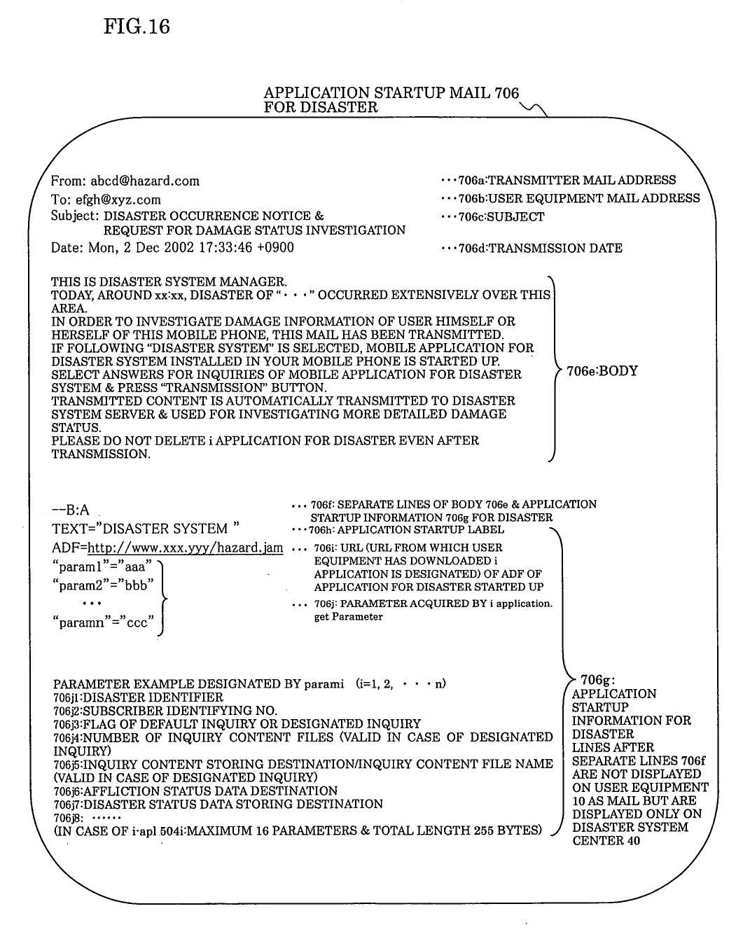

Steps T210, T220 1-T220 n (hereinafter, occasionally represented by a reference numeral T220): Startup information 706g (see FIG. 16 described later) of the application 11 for disaster installed on each user equipment 10 is included in this urgent notice mail/application startup mail 706 for disaster. Based on the startup information 706g, the application 11 for disaster of each user equipment 10 displays inquiries to the subscriber, and transmits a response (disaster status information response) 707 thereof to the disaster system center 40 with HTTP (Hypertext Transfer Protocol) protocol.

Analysis Processing of Disaster Status Information Database

Steps T230 and T240: In the disaster system center 40, the database analyzer 44c (see FIG. 5) stores in the response information database 44g the disaster status information included in the disaster status information response 707, and analyzes the disaster status information based on the database 44g. The database analyzer 44c determines the number of afflicted subscribers of e.g. afflicted object nodes B20_1-B20_3.

Bandwidth Correction for Disaster

Steps T240 and T250: The disaster system center 40 transmits bandwidth correction control instructions 708 including the node B No./the number of afflicted subscribers associating the number of afflicted subscribers determined with the node B20, to the RNC 30_1 (see FIG. 2) accommodating the nodes B20_1-B20_3 with TCP/IP protocol.

Step T260: The RNC 30_1 performs the bandwidth restriction for disaster and the correction of the bandwidth change performed at step T120, regarding the designated nodes B20_1-B20_3.

Step T270: Hereafter, the disaster system control apparatus 100 repeats subsequent steps T271 and T272 as required.

Step T271: The transmission/reception of the disaster status information is performed between the disaster system center 40 and the application 11 for disaster of the user equipment 10.

Step T272: Based on the disaster status information, the bandwidth control for disaster of the RNC 30_1 is corrected.

Steps T280 and T290: When the disaster 400 has ended, the operator designates the node B No. where the disaster 400 has ended to the disaster system center 40. The disaster system center 40 transmits disaster end instructions 709 including the designated node B No. to the RNC 30 with TCP/IP protocol.

Step T300: The RNC 30 releases the bandwidth control for disaster of the nodes B20_1-B20_3 designated.

Step T310: The disaster system center 40 stops the disaster system control apparatus 100.

Thus, it becomes possible to give a preference to the PS call bandwidth over the other bandwidths at the time of the disaster occurrence, to reduce a congestion state, to make an urgent notice to the subscriber within the disaster occurrence area, and to acquire the disaster status information from the subscriber within the disaster occurrence area.

<RNC Processing Flow>

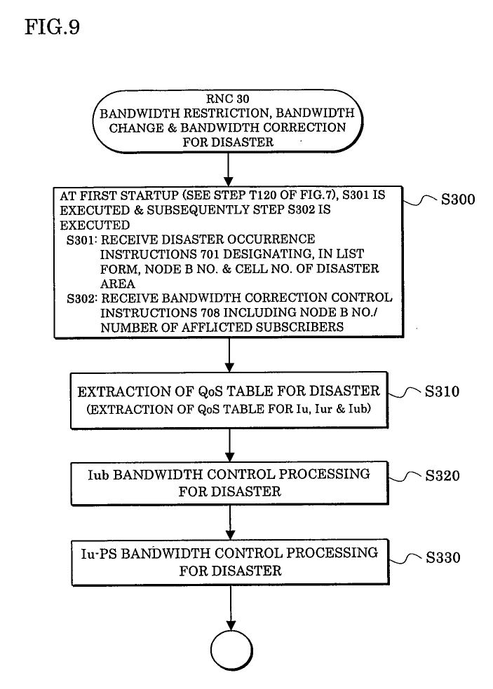

FIG. 9 shows a processing example of bandwidth securement for disaster in the bandwidth controller 31 (see FIG. 5) of the RNC 30. The processing example of the bandwidth securement for disaster includes (1) the bandwidth restriction and the bandwidth change processing for disaster shown at step T120 of FIG. 7, and (2) bandwidth correction processing for disaster shown at step T260 of FIG. 8. These processings will now be described in detail.

Step S300: At an initial time when the disaster occurrence state is not recognized, the bandwidth controller 31 receives the disaster occurrence instructions 701. When the disaster status is grasped subsequently, the bandwidth correction control instructions 708 is received.

The disaster occurrence instructions 701 are signals designating in a list form the node B No. and the cell No. “n” covering an area (cell) where the disaster 400 has occurred. The bandwidth correction control instructions 708 are signals designating in a list form the node No. and the number of afflicted people.

Step S310: In the RNC 30, the bandwidth controller 31 extracts QoS tables for disaster of the interface Iub and the interface Iu.

Steps S320 and S330: The IUB controller 32 and the IUPS controller 33 (see FIG. 5) of the bandwidth controller 31 respectively execute Iub bandwidth control processing for disaster and Iu-PS bandwidth control processing.

Thus, it becomes possible for the RNC 30 to control the bandwidth between the node B20 and the RNC 30 (interface Iub) in the disaster area, and the RNC 30 and the CN 300 (interface Iu). Namely, the RNC 30 applies a bandwidth assignment for disaster service, while reducing a bandwidth assignment for existing service.

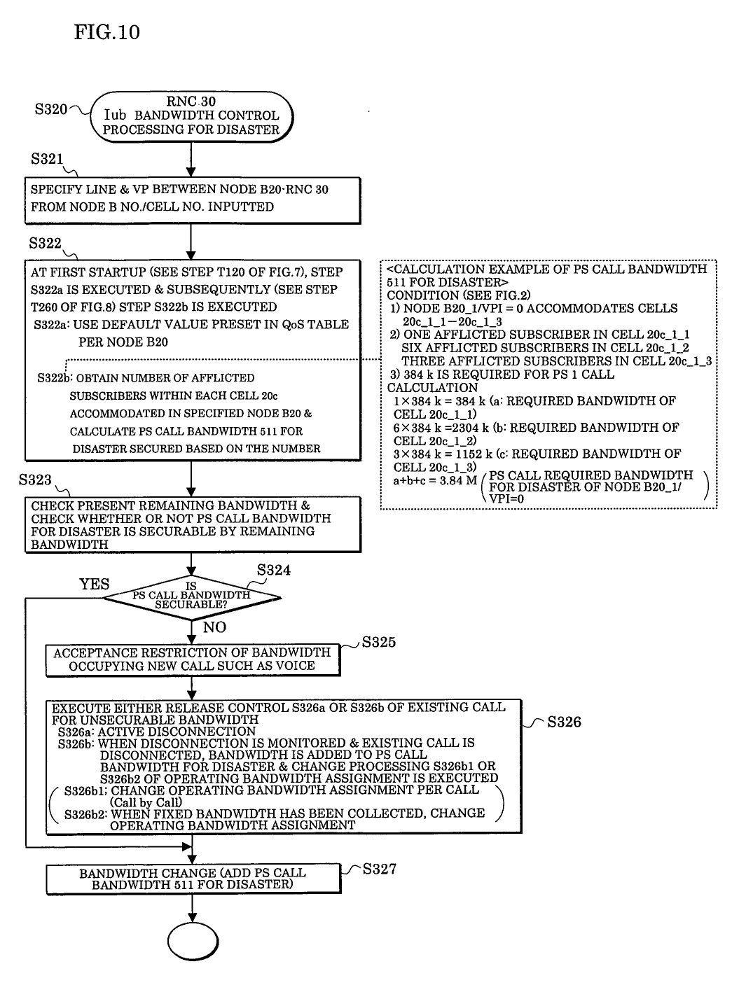

FIG. 10 shows in more detail the Iub bandwidth control processing S320 for disaster shown in FIG. 9. This processing S320 will now be described.

The QoS tables for assigning a bandwidth per service type at a normal state and assigning more bandwidth to a specific service type (PS calls) at a disaster state are preset in the RNC 30.

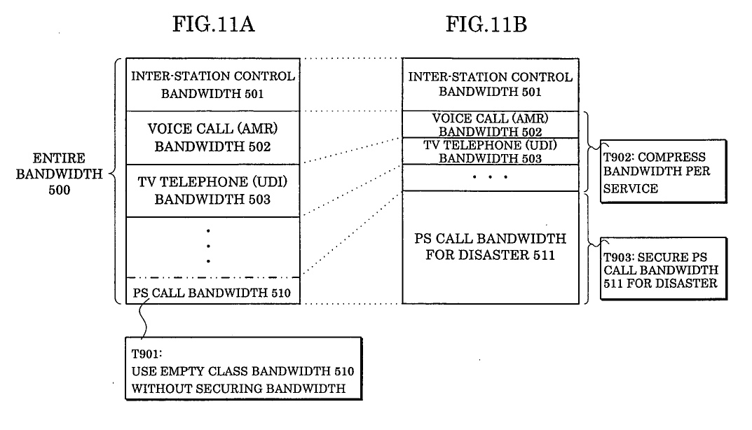

FIGS. 11A and 11B show these QoS tables, and a bandwidth control in each interface Iub (see FIG. 1). FIG. 11A shows a bandwidth control in a normal state. In the entire bandwidth 500, bandwidths for each service type, i.e. an inter-station control bandwidth 501, a voice call (AMR) bandwidth 502, a TV telephone (UDI) bandwidth 503, and the like are assigned. As for a PS bandwidth 510, a specific bandwidth is not secured but an empty class bandwidth 510 is used (see step T901 of FIG. 11A).

The mobile terminal 10 designates a service type upon calling to execute a call connection. The RNC 30 determines whether or not the bandwidth is securable at the designated service type, e.g. the voice call bandwidth 502 from the mobile terminal 10. When the bandwidth is insufficient, call processing assumes an abnormal state. Whether the RNC 30 can secure the bandwidth is determined based on whether or not a call connection required bandwidth exists, from remaining bandwidth information per service type owned by the RNC 30.

The remaining bandwidth information is defined as a bandwidth which can be obtained by the QoS information of the RNC 30.

Step S321: In the bandwidth controller 31 of the RNC 30, the IUB controller 32 (see FIG. 5) receives the disaster occurrence instructions 701 (see T110 of FIG. 7) or the bandwidth correction control instructions 708 (see step T250 of FIG. 8) designated by the operator of the disaster system center 40, and specifies a line and a VP (Virtual Path) between the node B20 and the RNC 30 based on the node B No./cell No. or the node B No./the number of afflicted people respectively included in the disaster occurrence instructions 701 or the bandwidth correction control instructions 708.

Step S322: At the first start up time (upon reception of disaster occurrence instructions 701), step S322a is executed, and subsequently (upon reception of bandwidth correction control instructions 708) step S322b is executed.

Namely, by changing the QoS information, a service bandwidth required upon disaster is set large, and other service bandwidths are set small, thereby executing the bandwidth control per service type.

Upon disaster a rate of voice calls by inquiry about the safety increases. Since a bandwidth required for a single call of voice is large, a bandwidth assignment of CSs call is reduced for effectively using the bandwidth, and the bandwidth assignment of the packet calls is increased.

Step S322a (bandwidth restriction and bandwidth change for disaster): At the first bandwidth change actuation, the IUB controller 32 switches the QoS table for normal state to the QoS table for disaster of a default value preset per node B, and performs the bandwidth control based on this QoS table.

Namely, the IUB controller 32 determines whether or not the service type (PS calls) bandwidth for disaster of the default value preset per node B20 can be secured by using the remaining bandwidth of the present available bandwidth. When the bandwidth is insufficient, the IUB controller 32 sequentially executes an acceptance restriction of a voice call bandwidth occupying new call until the QoS for disaster becomes available, executes a release control of an existing call for the insufficient bandwidth, executes the reduction of other bandwidths, and executes the bandwidth change until the QoS for disaster becomes available.

Step S322b (bandwidth correction for disaster): The IUB controller 32 calculates the PS call bandwidth for disaster secured based on the number of afflicted subscribers within the cell 20c accommodated in e.g. a specified node B20 periodically provided from the disaster system center 40. Namely, the IUB controller 32 secures the PS bandwidth for disaster which is larger than that of the default value when the number of afflicted subscribers is large, and secures the PS bandwidth for disaster which is smaller than that of the default value when the number of afflicted subscribers is small. Thus, it becomes possible to secure the PS bandwidth for disaster according to the disaster scale.

In FIG. 2 for example, the numbers of afflicted subscribers within the cells 20c_1, 20c_2, and 20c_3 accommodated in the node B20_1 are respectively 1, 6, and 3. If 384 kbps is supposed to be required per single call of a packet call, the PS call required bandwidth for disaster of the node B20_1/VPI=0 is (1+6+3)×384 k=3.84 Mbps.

Steps S323 and S324: The IUB controller 32 checks the present remaining bandwidth to determine whether or not the PS call bandwidth (default value or calculated value=3.84 Mbps) for disaster can be secured by the remaining bandwidth. When it is found securable, the process proceeds to step S327. When it is found not securable, the process proceeds to subsequent step S325.

Step S325: Firstly, the IUB controller 32 restricts the acceptance of a new call occupying the bandwidth of a voice or the like. Thus, the new voice call is restricted after the disaster occurrence and preference is given to the packet calls.

Step S326: Furthermore, when the securement of the PS call bandwidth (default value or calculated value=3.84 Mbps) for disaster is impossible, the IUB controller 32 executes control processing S326a or 326b of releasing the existing call.

Step S326a: The IUB controller 32 secures the PS call bandwidth for disaster by actively disconnecting the existing call.

Step S326b: The IUB controller 32 monitors the disconnection of the existing call, adds the released bandwidth to the PS call bandwidth for disaster at the time of disconnection, and executes processing bandwidth assignment changes in operation S326b1 or S326b2.

Step S326b1: The IUB controller 32 changes the bandwidth assignment in operation every time an existing call is disconnected.

Step S326b2: The IUB controller 32 changes the bandwidth assignment in operation when the existing call is disconnected and the released bandwidths are collected to assume a bandwidth of a fixed value.

Step S327: The IUB controller 32 changes (adds) the PS call bandwidth for disaster. Thus, as shown in FIG. 11B, the voice call bandwidth 502 and the TV telephone bandwidth 503 . . . in the entire bandwidth 500 are compressed (see step T902), and the PS call bandwidth 511 for disaster is secured (see step T903), so that the congestion state of the bandwidth for disaster can be reduced.

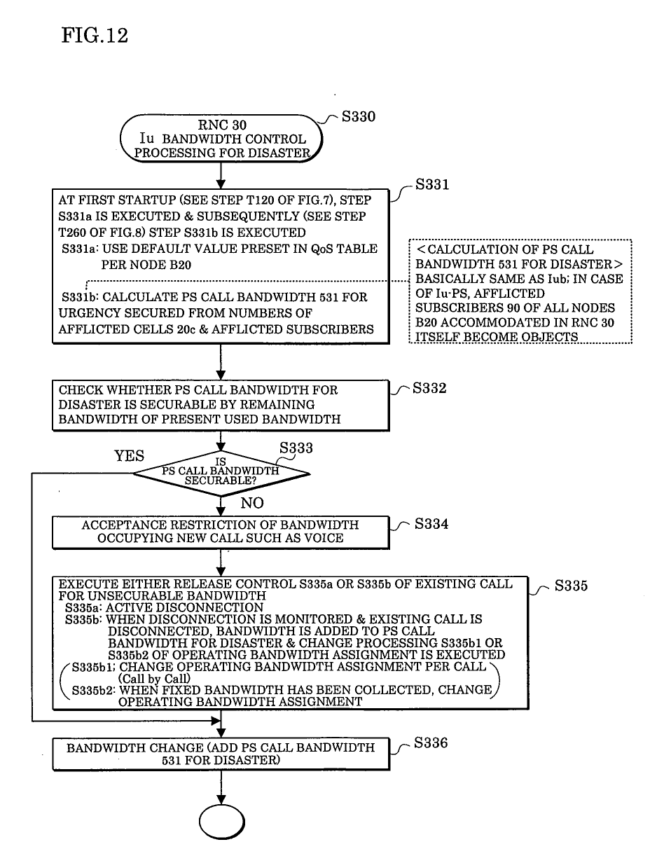

FIG. 12 shows in more detail the lu-PS bandwidth control processing S330 for disaster shown in FIG. 9. This processing S330 will now be described.

In the same way as the IUB bandwidth control processing S320 for disaster, in the RNC 30, a QoS table of preliminarily assigning much bandwidth to a specific service type (packet calls) upon disaster is set in the interface Iu (see FIG. 2).

It is to be noted that while the Iub bandwidth control processing S320 for disaster controls the bandwidth per interface lub with the node B20, the Iu-PS bandwidth control processing S330 for disaster controls the interface Iu-PS bandwidth with the core network 300. Therefore, the bandwidth for the afflicted subscribers of all of the nodes B20 accommodated in the RNC 30 is to be calculated.

Step S331: In the bandwidth controller 31 of the RNC 30, the IUPS controller 33 (see FIG. 5) receives the disaster occurrence instructions 701 (see step T110 of FIG. 7) or the bandwidth correction control instructions 708 (see step T260 of FIG. 8), and specifies a line and a VP (Virtual Path) between the core network 300 and the RNC 30 based on the node B No. included in the disaster occurrence instructions 701 or the bandwidth correction control instructions 708, respectively.

At the first startup time (at the time of reception of the disaster occurrence instructions 701 of FIG. 7), processing S331a is executed, and subsequently (at the time of reception of the bandwidth correction control instructions 708 of FIG. 9), the processing S331b is executed.

Step S331a (bandwidth restriction and bandwidth change for disaster): The IUPS controller 33 secures the bandwidth of the default value preset in the QoS table per node B20.

Step S331b (bandwidth correction for disaster): The PS call bandwidth for disaster secured is calculated from the numbers of afflicted cells 20c and afflicted subscribers.

For example, in FIG. 2, the numbers of afflicted subscribers in the afflicted cells 20c_1_1-20c_1_3, 20c_2, and 20c_3 are respectively 1, 6, 3, 5, and 3, so that the number of all the afflicted subscribers is 18. Supposing that a single packet call is 384 kbps, the required PS call bandwidth is 18×384 kbps=6.912 Mbps.

Steps S332 and S333: The present remaining bandwidth is checked to determine whether or not the PS call bandwidth (default value or calculated value) for disaster can be secured with the remaining bandwidth. When the PS call bandwidth is securable, the process proceeds to step S336. When the PS call bandwidth is not securable, the process proceeds to step S334.

Steps S334-S336: These steps are the same as steps S325-S327 shown in FIG. 10.

Thus, the preference is given to the packet calls which can transmit much information than the voice calls, so that the congestion at the time of disaster can be reduced.

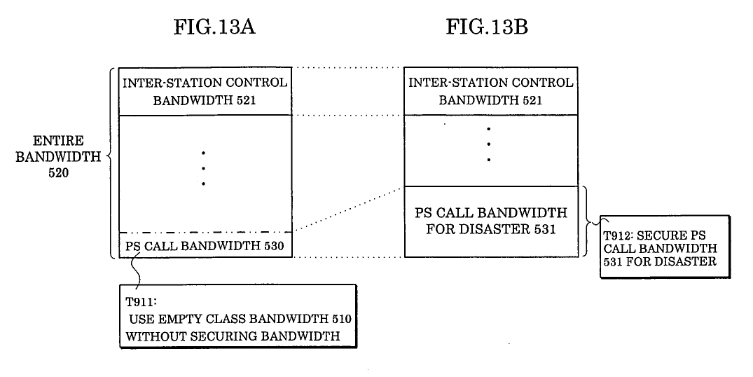

FIGS. 13A and 13B show a QoS information example of the IU bandwidth, in which FIG. 13A shows a bandwidth in a normal state, and FIG. 13B shows a bandwidth in a disaster state. In the normal state, an inter-station control bandwidth 521 . . . is secured in an entire bandwidth 520, and an unoccupied class bandwidth is used for a PS call bandwidth 530. In the disaster state, a PS call bandwidth 531 for disaster determined by the default value or the calculated value is secured.

<Processing Flow by DS, HLR, and Mail Server>

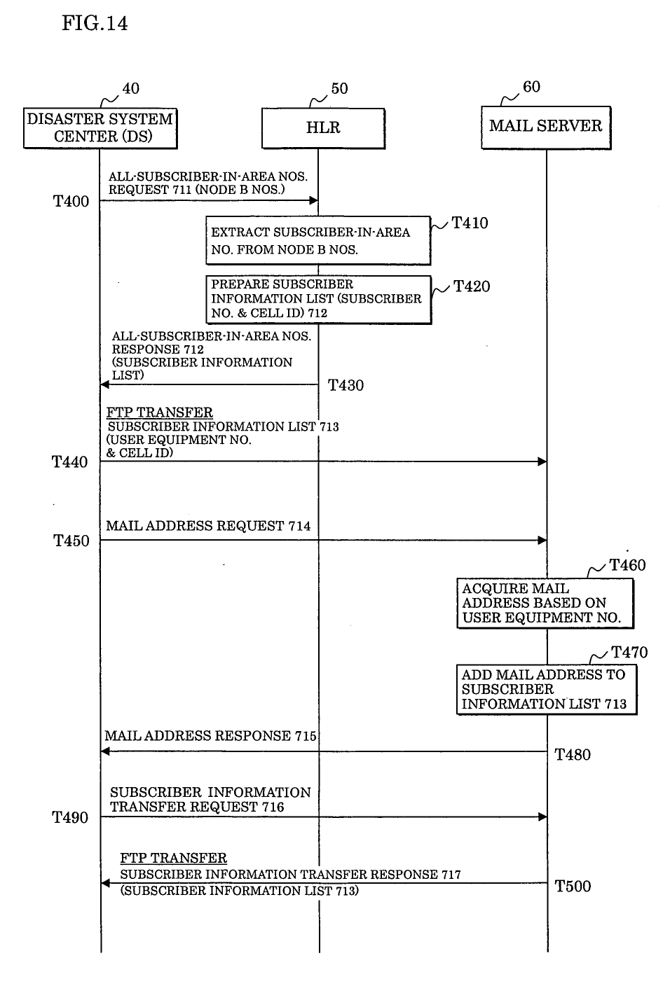

FIG. 14 shows in more detail the operation procedure (steps T130-T180 in urgent notice processing S130) acquiring the mail address of the subscriber shown in FIG. 7. Namely, the disaster system center 40 acquires subscriber information (position information (cell identifier), telephone No., mail address, and the like) for giving urgent notice by mail to the subscribers within the disaster occurrence area.

When the cell 20c in which the mobile terminal 10 is located is not recognized, it is impossible to call the mobile terminal 10 from the core network 300. Accordingly, every time the mobile terminal 10 moves the cell 20c (registration area) on a routing within the mobile communication network, it is required to register the area where the mobile terminal 10 itself is located.

A general method of a registration will now be described.
(1) The node B20 informs an area No. indicating a position registration area in which the mobile terminal 10 is located by radio lines.
(2) The mobile terminal 10 always checks the area No. presently informed against the area No. stored by the mobile terminal 10 itself. When they do not mutually match, it is recognized that the mobile terminal 10 has moved to a new cell 20c (area).
(3) The mobile terminal 10 transmits a position registration signal to the network, so that a switchboard having received the position registration signal converts the signal into position information by which routing within the network is enabled, and transmits the position information to the HLR 50.
(4) The HLR 50 stores the received position information in a MAPDATA associated with a mobile terminal No. The MAPDATA is composed of the mobile terminal No., the RNC 30, the node B20, the cell 20c, and the like.

Also, a mobile phone carrier has a mail server 60 managing accounts, which associates the mobile terminal No. with the mail address presently used to be stored, in order to hold a default mail address (mail address whose top is a telephone No.) and a mail address designated by the user.

In the disaster system control apparatus 100 of the present invention, the subscriber-in-area No. acquiring portion 51 (see FIG. 5) of the HLR 50 has a function of retrieving a concerned mobile phone subscriber telephone No. in the position registration area designated by the disaster system center 40 to be notified to the disaster system center 40. The subscriber mail address acquiring portion 61 (see FIG. 5) of the mail server 60 has a function of retrieving a mail address corresponding to the mobile terminal No. to be notified to the disaster system center 40. At the time of the disaster occurrence, the functions are started up by the instructions from the disaster system center 40. The disaster system center 40 subsequently transmits the urgent notice mail or the startup mail based on the mail address obtained from the mail address acquiring portion 61.

This operation procedure will now be described.

Step T400: The disaster system center 40 provides to the HLR 50 an all-subscriber-in-area No. request 711 including the No. of the node B20 in the disaster occurrence area.

Step T410: The HLR 50 extracts the subscriber No. corresponding to the node B No. from the MAPDATA (RNC No., node B No, cell identifier, mobile terminal No. (subscriber No.)).

Steps T420 and T430: Furthermore, the HLR 50 prepares a subscriber information list associating the subscriber No. with the cell identifier, and informs the subscriber information list to the disaster system center 40 as an all-subscriber-in-area No. response 712.

Steps T440 and T450: The disaster system center 40 prepares a subscriber information list (subscriber No. and cell identifier) 713 to be provided to the mail server 60.

Furthermore, the disaster system center 40 transmits a mail address request 714 to the mail server 60.

Steps T460 and T470: The mail server 60 retrieves a mail address from the mail address of the existing information and the mobile terminal No., and adds the mail address in the subscriber information list.

Step T480: The mail server 60 transmits the mail address response 715 indicating that the mail address has been acquired to the disaster system center 40.

Step T490: The disaster system center 40 provides a subscriber information transfer request 716 to the mail server 60.

Step T500: The mail server 60 provides the subscriber information list including the mail address to the disaster system center 40.

Thus, it becomes possible for the disaster system center 40 to sequentially transmit an urgent notice mail/startup mail or the like to the mail address acquired.

<Startup Processing Flow of Terminal>

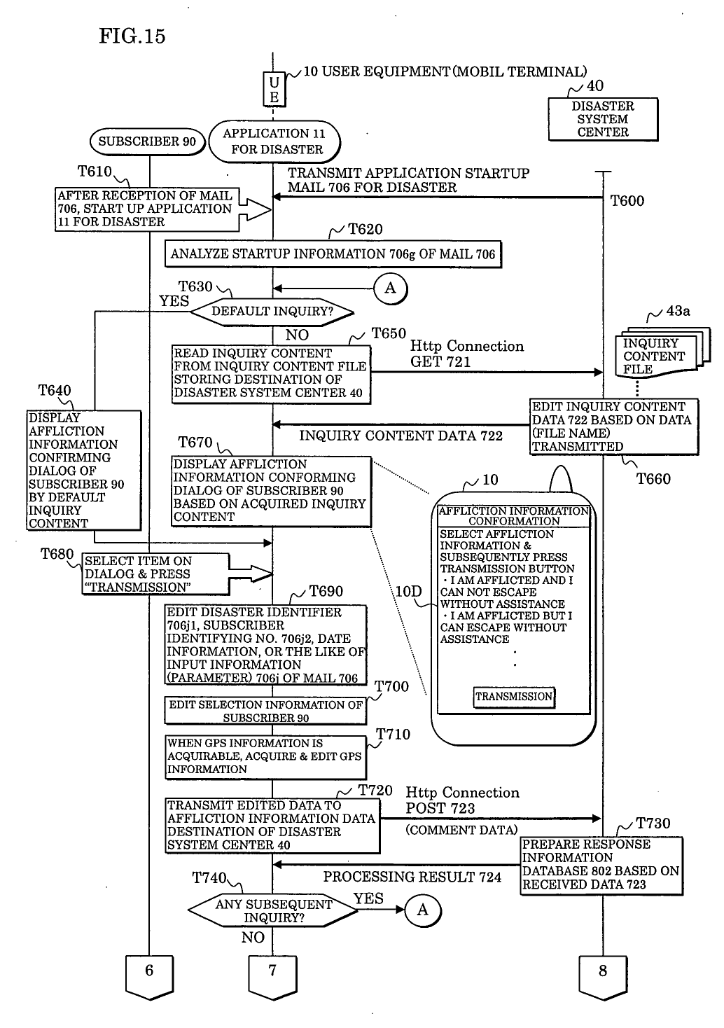

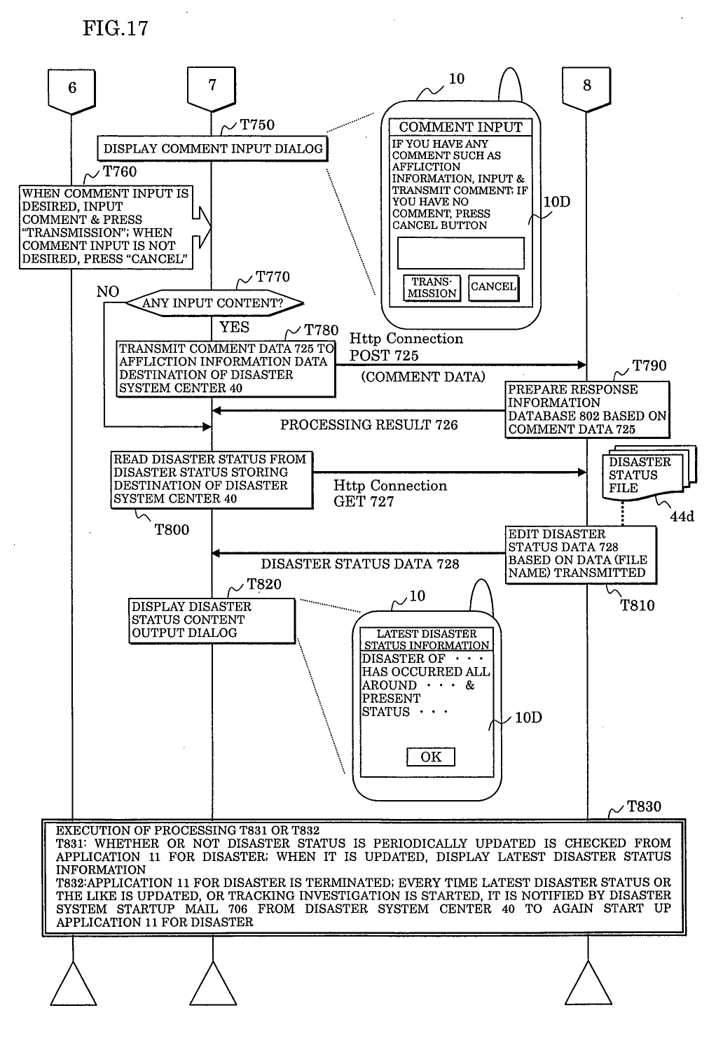

FIGS. 15 and 17 respectively show operation procedure examples (Nos. 1 and 2) of the application for disaster, which indicate in more detail steps T200-T220 shown in FIG. 7 and step T271 shown in FIG. 8. These operation procedure examples will now be described.

Step T600: The disaster system center 40 provides the application startup mail 706 for disaster to the mobile terminal (user equipment) 10.

FIG. 16 shows one example of the application startup mail 706 for disaster. This startup mail 706 is composed of a transmitter mail address 706a, a user equipment mail address 706b, a subject 706c, a transmission date 706d, a body 706e, a separate line 706f, and application startup information 706g.

The application startup information 706g is composed of a URL 706i of an ADF and a parameter 706j. The parameter 706j can be composed of a single or a plurality of parameters. As the parameter, a disaster identifier 706j1, a subscriber identifying No. 706j2, a flag 706j3 indicating a default inquiry or a designated inquiry, the number of inquiry content files 706j4 which become effective in case of the designated inquiry, a storing destination of inquiry content/inquiry content file name 706j5 which becomes effective in case of the designated inquiry, an affliction status data destination 706j6, a disaster status data storing destination 706j7, and the like can be mentioned.

Step T610: The subscriber 90 of the mobile terminal 10 reads the body 706e of the startup mail 706 and selects a “disaster system” displayed at the bottom. Since the display of the “disaster system” is an application startup label 706h=“TEXT=disaster system”, characters “disaster system” is displayed at the bottom of the mail body. The subscriber selects the link, so that the startup of the application is executed.

Step T620: In the mobile terminal 10, the application 11 for disaster is started up, so that the startup information 706g (see FIG. 16) of the startup mail 706 is analyzed. Namely, since the URL 706i=“ADF=http://www.xxx.yyy/hazard.jam” which is the ADF of the application for disaster in the startup information 706g coincides with the URL of the ADF of the concerned application stored when the mobile phone has downloaded the application for disaster, it is recognized that the mail 706 is the application startup mail for disaster, so that the application for disaster is started up. The started up-application for disaster analyzes e.g. the disaster identifier 706j1, the subscriber identifying No. 706j2, the flag 706j3 of “default inquiry”/“designated inquiry”, the number of inquiry content files (effective in case of designated inquiry) 706j4, storing destination of inquiry content/inquiry content file name (effective in case of designated inquiry) 706j5, the affliction status data destination 706j6, the disaster status data storing destination 706j7, and the like designated by the parameter 706j.

Step T630: When the flag 706j3 indicates the “default inquiry”, the process proceeds to step T640. When it indicates the “designated inquiry”, the process proceeds to step T650.

Step T640: The inquiry data display function 13 (see FIG. 5) of the application 11 for disaster dialogically displays the “default inquiry” of a selection form preset in the application 11 on a display portion 10D (see FIG. 15) of the mobile terminal 10.

Step T680: The subscriber 90 selects the item on the dialog display, and presses “transmission”.

Step T650: The disaster information transmission/reception function 12 (see FIG. 5) of the application 11 for disaster provides a GET 721 of HTTP protocol to the disaster system center 40 in order to read the inquiry content from the inquiry content file 43a (see FIG. 5) of the disaster system center 40.

Step T660: In the disaster system center 40, the inquiry data editor 43b (see FIG. 5) takes out the inquiry content data 722 from the inquiry content file 43a, and edits the data 722 to be returned to the mobile terminal 10.

Step T670: In the mobile terminal 10, the inquiry data display function 13 dialogically displays the inquiry content data 722 of the selection form received through the disaster information transmission/reception function 12 on the display portion 10D (see FIG. 15). The inquiry contents of the selection form are e.g. (1) “I am not afflicted”, (2) “I am afflicted but have already escaped”, (3) “I am afflicted but I can escape without assistance”, (4) “I am afflicted and I can not escape without assistance”, and the like.

Step T680: The subscriber 90 selects the item on the dialog display and presses “transmission”.

Step T690: The disaster information data edit function 14 (see FIG. 5) of the application 11 for disaster edits the service disaster identifier 706jl, the subscriber identifying No. 706j2, date information, and the like (see FIG. 16) of the startup information 706g in the startup mail 706.

Step T700: Also, the affliction information data edit function 14 edits the selection information of the subscriber 90.

Step T710: Furthermore, the affliction information data edit function 14 acquires and edits GPS information when the GPS information can be acquired.

It is to be noted that when the following condition (1) or (2) is satisfied, a mobile application of the mobile terminal 10 can generally acquire the GPS information.
Condition (1): The mobile terminal 10 installs thereon an acquisition function of the GPS information such as gpsOne system of Qualcomm;
Condition (2): The mobile terminal 10 installs thereon a platform for the mobile terminal by which the mobile application can acquire the gps information by accessing the gpsOne function such as BREW of the Qualcomm.
   Step T720: The affliction information data edit function 14 edits the affliction information or the like edited at steps T690-T710 as a parameter/comment data of a database preparation program (program in servlet form) on the disaster system center 40, and transmits the data to the affliction information data editor 43c (see FIG. 5) of the disaster system center 40 by using Post 723 of HTTP protocol.
   Step T730: The database information portion 44b prepares the response information database 44d based on the parameter/comment data transmitted by the POST 723 through the affliction information data editor 43c, and transmits a processing result 724 to the mobile terminal 10.
   Step T740: In the presence of a subsequent inquiry in the mobile terminal 10, the process returns to step T630, and repeats steps T630-T730.

FIG. 17 shows an operation procedure example (No.2) of the application for disaster. This operation procedure example (No.2) will now be described.

Step T750: The inquiry data display function 13 (see FIG. 5) of the mobile terminal 10 displays the comment input dialog in the display portion 10D.

In the comment dialog, a mobile terminal subscriber can freely input additional information and comment (text information).

It is to be noted that a dialog for selecting any one of “comment”, “image data”, “moving image data” and “voice data” is displayed on the display portion 10D instead of displaying the comment input dialog, and the input dialog of a comment, static image, moving image, voice, or the like is displayed according to the selection of the subscriber, so that the comment, static image, moving image, or the voice may be transmitted to the disaster system center 40.

Step T760: When the subscriber 90 desires to input a comment, he or she inputs the comment and then presses “transmission”. When the subscriber does not desire to input the comment, he or she presses “cancel”. When the subscriber 90 presses “cancel” and terminates the application for disaster 11 without notifying the selection result, the information that the application has been compulsorily terminated is notified to the disaster system center 40.

Step T770: When “cancel” is pressed without comment, the process proceeds to step T800 at which “transmission” is pressed. When there is a comment, the process proceeds to step T780.

Step T780: The affliction information data edit function 14 edits the comment data 725 (moving image, static image, or voice data) inputted by the subscriber and the disaster identifier 706j 1, the subscribe identifying No. 706j2, the date information, and the like of the startup information 706g (see FIG. 16) as a parameter of the database preparation program (program in servlet form) installed on the disaster system center 40.

The affliction information data edit function 14 calls the database preparation program by POST 725 of HTTP protocol.

Step T790: The database preparation program of the disaster system center 40 prepares the response information database 44g based on the comment/parameter data transmitted, and returns a processing result 726 to the mobile terminal 10.

Step T800: When the subscriber 90 desires to read the latest disaster information, the mobile terminal 10 requests to read the disaster status file on the disaster system center 40 by GET 727 of HTTP protocol.

Step T810: The disaster system center 40 edits the disaster status data 728 based on the data (file name) transmitted, and returns the disaster status data 728 to the mobile terminal 10.

Step T820: In the mobile terminal 10, the disaster information display function 15 dialogically displays the display status data 728 received through the disaster information transmission/reception function 12 on the display portion 10D as the latest disaster status information.

Step T830: Subsequent processing T831 or T832 is executed.

Step T831: Whether or not the disaster status is periodically updated is checked by the application 11 for disaster. When it is updated, the latest disaster status information is displayed.

Step T832: Every time the mobile application is once terminated and the latest disaster status or the like is updated or a tracking investigation is started, the startup mail 706 is notified again from the disaster system center 40, so that the application 11 for disaster is started up again.

Thus, it becomes possible to grasp the affliction occurrence status of the disaster occurrence area.

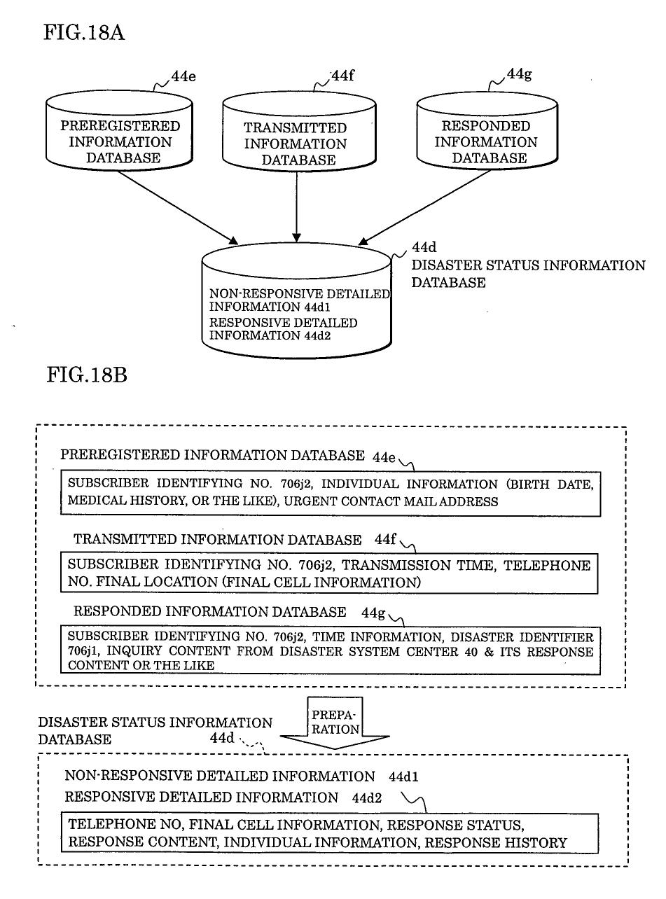

FIG. 18A shows a database example held by the disaster system center 40. In this database example, the disaster system center 40 is provided with (1) preliminary registered information database 44e, (2) transmitted information database 44f, (3) responded information database 44g, and (4) disaster status information database 44d.

The disaster status information database 44d is a database prepared by analyzing the transmitted information database 44f, the responded information database 44g, and the preregistered information database 44e, and includes non-responsive detailed information 44d1 and responsive detailed information 44d2.

FIG. 18B shows in more detail the contents of the databases 44f, 44g, 44e, and 44d shown in FIG. 18A. These databases 44f, 44g, 44e, and 44d will now be described.

(1) Preregistered Information Database 44e

This is a database which a subscriber preregisteres in the disaster system center 40 for analyzing data at the time of a disaster and providing services. The database 44e is composed of a subscriber identifying No., individual information (birth date, medical history, and the like), an urgent contact destination mail address, and the like.

(2) Transmitted Information Database 44f

This is a database for storing mail transmission information upon transmitting messages by the disaster system center 40, and for storing a history of required information referred to when the disaster system center 40 prepares the detailed information database 44d.

The database 44f is composed of a subscriber identifying No., a transmission time, a telephone No., a final location (final cell information), and the like.

(3) Responded Information Database 44g

This is a database in which the contents responded by the mobile terminal 10 to the disaster system center 40 are held, and the history of necessary information referred to when the disaster system center 40 prepares the disaster status information database 44d (non-responsive detailed information 44d1 and responsive detailed information 44d2).

The database 44g is composed of the subscriber identifying No. 706j2, the time information, the disaster identifier 706j1, the inquiry content from the disaster system center 40, its response content, and the like.

(4) Disaster Status Information Database 44d

This is a database holding a result of an analysis of databases 44e, 44f, and 44g by the disaster system center 40. The database 44d is composed of a telephone No., final cell information, a response status, a response content, individual information, a response history, and the like.

The telephone No. indicates a telephone No. of a subscriber 90 in the afflicted area, and the final cell information indicates a final location cell of the subscriber in the afflicted area. The response status is information indicating presence/absence of a response for a mail after a fixed time lapse after the mail transmission to the subscriber 90 by the disaster system center 40. The response content indicates a content of a response mail from the mobile terminal 10, the individual information is information acquired from the preregistered information, and the response history is a history of the response status.

The disaster system center 40 can prepare e.g. an afflicted people status and an afflicted people list based on the disaster status information database 44d and can provide information to public organizations or the like.

<DS Processing Flow>

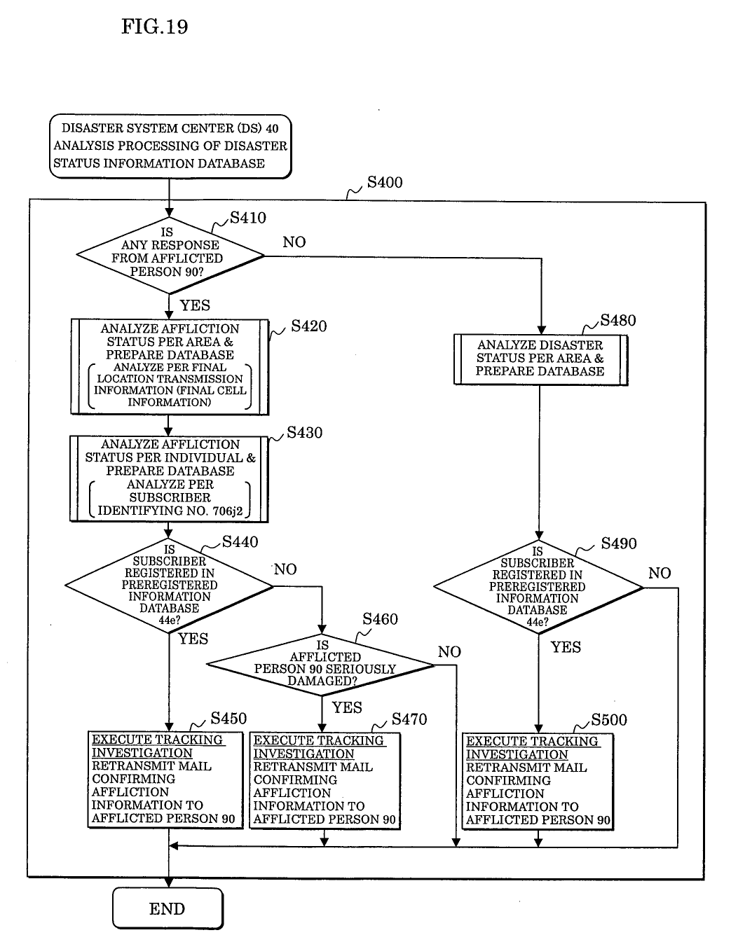

FIG. 19 shows in more detail an analysis processing example of the disaster status information database of step S150 in FIG. 3, i.e. the processing example of step T230 shown in FIG. 7. In this analysis processing, the disaster system center 40 performs the analysis and preparation of the database 44d shown in FIGS. 18A and 18B, and grasps an affliction status in the disaster occurrence area. This processing example will now be described.

Step S410: In the presence of the disaster status information response 707 (see step T210 of FIG. 7) for the urgent notice mail/startup mail 706 from the subscriber (afflicted person) 90, the process proceeds to step T420 at the disaster system main controller 44a in the disaster system center 40. In the absence of the response 707, the process proceeds to step T480.

Step S420: The database analyzer 44c analyzes the affliction status per area (final location transmission information, i.e. final cell information).

Step S430: Furthermore, the database analyzer 44c analyzes the disaster status per individual (subscriber identifying No.), and determines e.g. an order of subscribers requiring an urgent rescue.

Steps S440 and S450: The database analyzer 44c determines whether or not the subscriber 90 is registered in the preregistered information database 44e based on the responded subscriber identifying No. When the subscriber is preregistered, the tracking investigation is executed. Namely, the database analyzer 44c requests the transmission of the disaster information confirming mail again from the urgent notifying processor 42.

Thus, if the individual information such as a medical history, a birth date, and an urgent contact destination mail is registered in the preregistered information database 44e, more accurate rescue activity can be performed.

Step S460: When the subscriber 90 is not preregistered in the preregistered information database 44e, the database analyzer 44c determines whether or not the subscriber is seriously damaged based on the response to the response message inquiry. When the subscriber is not seriously damaged, the process is ended.

Steps S460 and S470: When the subscriber is seriously damaged, the database analyzer 44c executes the tracking investigation. Namely, the database analyzer 44c again requests the transmission of the affliction information confirming mail to the afflicted person from the urgent notifying processor 42.

Step S480: The database analyzer 44c compiles the subscribers without response 707 per area in spite of the transmission to the mobile terminal 10, and analyzes the affliction status per area (final location transmission information, i.e. final cell information).

Steps S490 and S500: The database analyzer 44c determines whether or not the subscriber 90 is registered in the preregistered information database 44e. When the subscriber is preregistered, the tracking investigation is executed. Namely, the database analyzer 44c again requests the transmission of the affliction information confirming mail to the afflicted person from the urgent notifying processor 42.

The analysis examples (1) and (2) performed by the database analyzer 44 will now be described.

(1) Analysis Based on Presence/Absence of Response to the Disaster System Center 40 from the Mobile Terminal 10

The disaster system center 40 obtains a response ratio per area, and ranks affliction. Namely, the affliction rank is determined by the ratio between the number of all of the subscribers in the area to which the disaster system center 40 has transmitted and the number of response messages.

(2) Analysis Based on the Affliction Status Mail to the Disaster System Center 40 from the Mobile Terminal 10.

The disaster system center 40 acquires and ranks the affliction status per individual, and prepares an order table of an urgent rescue. Namely, based on the subscriber information (age and gender) preregistered in the disaster system center 40 and the affliction status rank of the messages transmitted from the mobile terminal 10, the rescue order table is prepared. This table is notified to an emergency center and a hospital.

Also, the disaster system center 40 informs as an additional service the affliction status to specific afflicted people and enterprises having subscribed for an additional service. It is also possible for the disaster system center 40 to communicate the information by mail based on the preregistered information (urgent contact destination mail address) registered in the disaster system center 40.

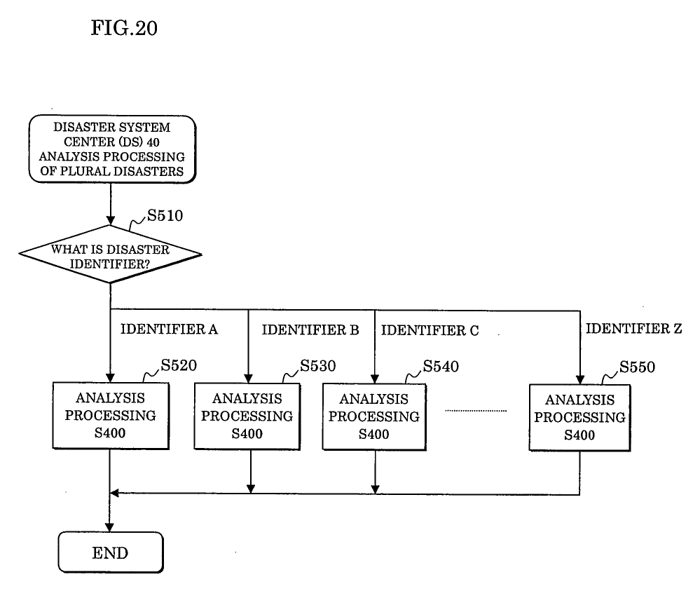

FIG. 20 shows an analysis processing example in a case where a plurality of disasters have occurred. This analysis processing example will now be described.

When a plurality of disasters have occurred, different disaster identifiers (706j1 of FIG. 16) are provided to each of the disasters.

Step S510: The database analyzer 44c classifies the responses 707 based on the disaster identifiers 706j1=“A”, “B”, “C”, . . . , “Z” included in the responses 707, and the process proceeds to steps S520, S530, S540, . . . , S550 respectively corresponding to the disaster identifiers

Step S520: The database analyzer 44c executes the analysis processing corresponding to a disaster A. This analysis processing is the same as step S400 shown in FIG. 19.

Steps S530-S550: In the same way as step S520, the database analyzer 44c executes analysis processing corresponding to disasters B-Z respectively.

By using such a disaster identifier, it becomes possible to analyze a plurality of disasters without confusing them.

It is to be noted that while a different disaster identifier is used for each disaster and disasters are classified in the above-mentioned analysis, the disasters may be analyzed by using the identifier which classifies information concerning the same disaster more minutely.

For example, an identifier=A01 for the first inquiry from the disaster system center 40 concerning the disaster whose identifier=“A”, an identifier=A02 for the second inquiry, an identifier=A03 for the third inquiry, an identifier=B01 for the first inquiry from the disaster system center 40 concerning the disaster whose identifier=“B”, and the like can be mentioned.

Also, the disaster system center 40 changes each parameter of the preregistered information database 44e, the transmitted information database 44f, and the responded information database 44g, and utilizes the disaster status information database (non-responsive detailed information 44d1, and responsive detailed information 44d2) 44d which is an analysis result of the databases, thereby enabling numerous services to be provided. The service examples (1)-(5) will now be described.
Service (1): The disaster system center 40 performs a data analysis with cell information made a key, and ranks affliction statuses based on the mail response ratio and the response content. It is possible to provide a guideline of rescue activities and recovery operations to rescue workers and recovery workers.
Service (2): The disaster system center 40 can perform a data analysis per subscriber 90 and can rank the rescue activities.
Service (3): The disaster system center 40 manages the mail addresses per cell, thereby enabling effective information corresponding to a cell to be broadcast.
Service (4): The afflicted person (subscriber) 90 registers preliminary information (urgent contact destination or the like) in the disaster system center 40, thereby enabling the contents of the response mail from the mobile terminal 10 to be transmitted to the preregistered designated destination mail address.
Service (5): Confirmation of safety from families, friends, and the like of the afflicted person 90 and provision of information are possible.

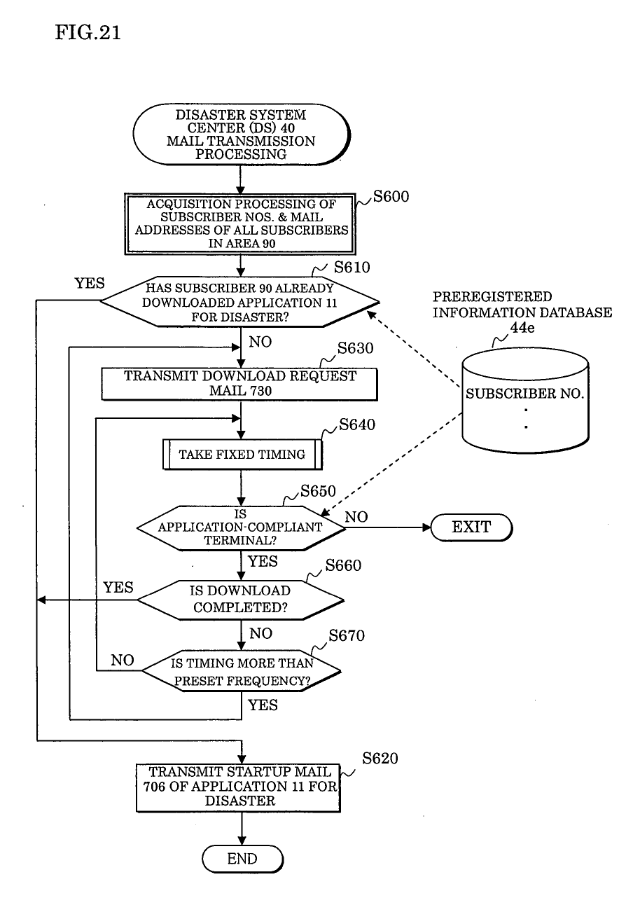

FIGS. 21-25 show operation procedures of downloading the application 11 for disaster to the mobile terminal 10 where the application 11 for disaster has not been installed and of starting up the application.

In e.g. “i-application 505”, it is possible to start up the “i-application” by mail. At the time of the startup, it is required that the i-application has been preliminarily downloaded to the mobile terminal 10.

Namely, even if the subscriber “selects & clicks” the application name displayed on the mail when an “i-application” startup mail is received at the terminal, no operation is performed unless the i-application has been preliminarily downloaded to the mobile terminal 10.

In the present invention, it is possible to download the application 11 for disaster to the terminal 10 where the application 11 for disaster has not been downloaded at the time of the disaster occurrence. As the operation procedure example of this download, the following operation procedure examples (1) and (2) can be mentioned. Download operation procedure example (1): The disaster system center 40 encourages, to download the application, the subscriber 90 of the terminal 10 where the application 11 for disaster has not been downloaded yet.

Download operation procedure example (2): The disaster system center 40 automatically (compulsorily) downloads the application 11 for disaster to the terminal 10 where the application 11 for disaster has not been downloaded.

FIG. 21 shows the download operation procedure example (1), in which the disaster system center 40 transmits to the subscriber 90 the application download request mail for disaster, and encourages the downloading. This operation procedure example (1) will now be described referring to FIG. 5.

When the subscriber 90 downloads the application 11 for disaster, the disaster system center 40 registers the subscriber No. of the subscriber 90 in the preregistered information database 44e. Accordingly, in the preregistered information database 44e, all of the subscriber Nos. of the subscriber having downloaded the application 11 for disaster are held.

Step S600: In the disaster system center 40, like steps T130-T180 of FIG. 7, the subscriber No. acquiring portion 45a acquires a subscriber No. of the subscriber-in-area 90 in a disaster forecasted area from the subscriber-in-area No. acquiring portion 51 of the HLR 50 (see FIG. 5). Also, the subscriber mail address acquiring portion 45b acquires a subscriber mail address corresponding to the subscriber No. acquired, from the subscriber mail address acquiring portion 61 of the mail server 60 (see FIG. 5).

Steps S610 and S620: When it is registered in the preregistered information database 44e that the subscriber No. acquired indicates the mobile terminal 10 which has downloaded the application 11 for disaster, the disaster system main controller 44a transmits the startup mail 706 of the application 11 for disaster to the mobile terminal 10.

Steps S610 and S630: When the mobile terminal 10 has not downloaded the application 11 for disaster, the disaster system main controller 44a transmits the download request mail 730 to the user equipment 10 through the urgent notifying processor 42.

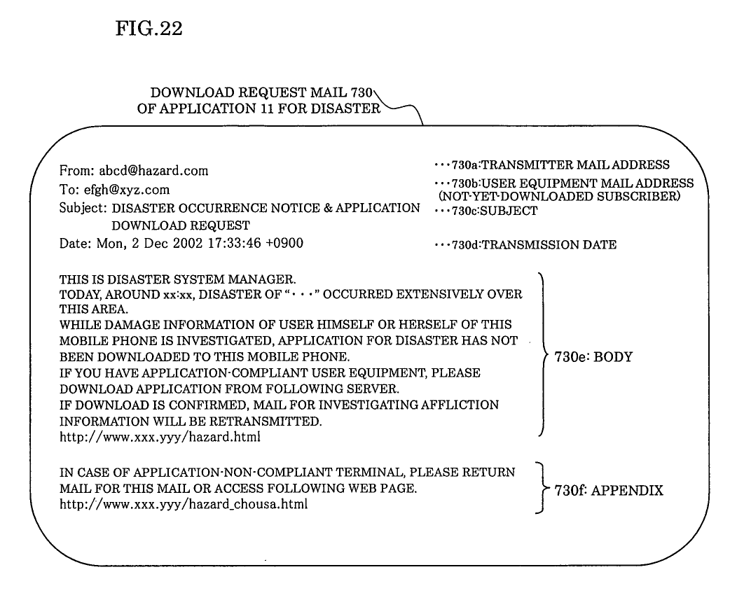

FIG. 22 shows an example of a download request mail 730 requesting the download of the application 11 for disaster. This mail 730 is composed of a transmitter mail address 730a, a user equipment (mobile terminal) mail address 730b, a subject 730c, a transmission date 730d, a body 730e, and an appendix 730f. It is to be noted that the user equipment 10 of the mail address 730b is a user equipment which has not downloaded the application 11 for disaster.

In the body 730e of the mail 730, downloading the application 11 for disaster is requested. The appendix 730f, when the user equipment 10 is not an application-compliant terminal, requests to return the mail to this mail 730 or to access a web page.

The subscriber 90 provides the disaster system center 40 with the notice that the user equipment 10 is not an application-compliant terminal by the methods of returning, accessing, inputting the subscriber No., and the like.

The disaster system center 40 adds the information that the concerned subscriber 90 is an application-non-compliant terminal in the preregistered information database 44e.

Hereafter, the disaster system center 40 does not transmit the download request mail 730 and the application startup mail 706 for disaster to the application-non-compliant terminal.

Thus, repeated transmissions of the download request mail 730 to the application-non-compliant terminal are prevented.

Steps S640 and S650: When the disaster system center 40 refers to the preregistered information database 44e after a fixed time and the subscriber 90 is an application-non-compliant terminal, the processing is ended.

Steps S650, S660, and S620: When the subscriber 90 is an application-compliant terminal and has already downloaded the application 11 for disaster, the disaster system center 40 transmits the application startup mail 706 for disaster to the concerned mobile terminal 10.

Steps S660 and S670: When the mobile terminal 10 has not downloaded the application 11 for disaster, the process returns to step S640, and steps S640-S670 are repeated. In the absence of a return mail nor access from the user equipment even if the repetition is performed more than preset times, the disaster system center 40 retransmits the download request mail 730.

It is to be noted that while the processing is performed to only one subscriber 90 at steps S610-S620 in the operation procedure example (1), this processing is performed to all of the subscribers 90 acquired at step S600.

Also, since the operation procedure example (1) is a method of checking whether or not the download has been completed based on the information of the preregistered information database 44e of the disaster system center 40, it is possible to perform the operation procedure example (1) by a function of a terminal installing a general application.

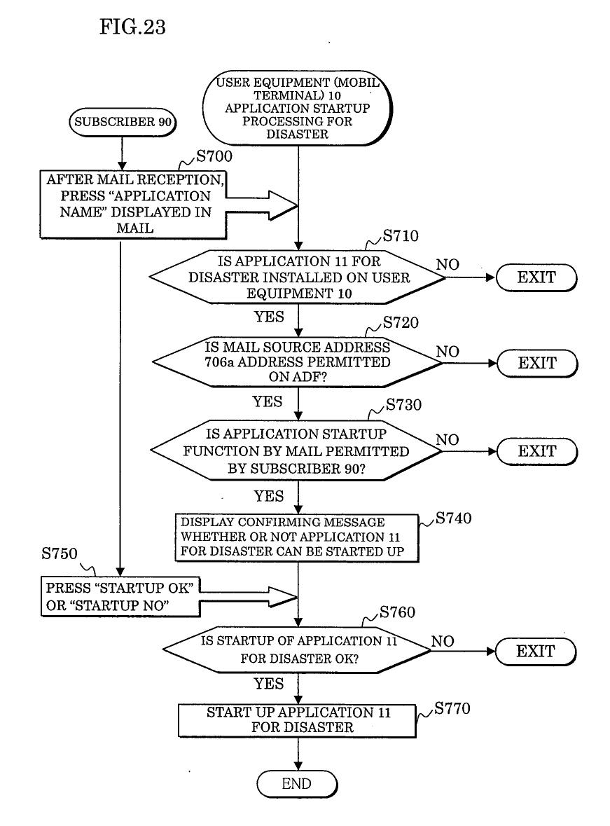

FIG. 23 shows in more detail the operation procedure in which the mobile terminal 10 starts up the application 11 for disaster. This operation procedure will now be described.

Step S700: The mobile terminal 10 receives the application startup mail 706 for disaster. The subscriber 90 presses “application name” displayed on the mail 706.

Steps S710-S730: When the application 11 for disaster is not installed and the mail source address is not an address permitted on the ADF, or when the subscriber 90 does not permit the application startup by mail, the application management component 16 (see FIG. 6) ends the processing.

Step S740: When the application 11 for disaster is installed, the mail source address is an address permitted on the ADF, and the subscriber 90 permits the application startup function by mail, the mobile terminal 10 displays a confirming message indicating whether or not the application 11 for disaster can be started up.

Step S750: The subscriber 90 presses “startup OK” or “startup NO”.

Steps S760 and S770: In case of “startup NO”, the processing is ended without startup. In case of “startup OK”, the application 11 for disaster is started up.

<Urgent Startup Processing Flow of Terminal>

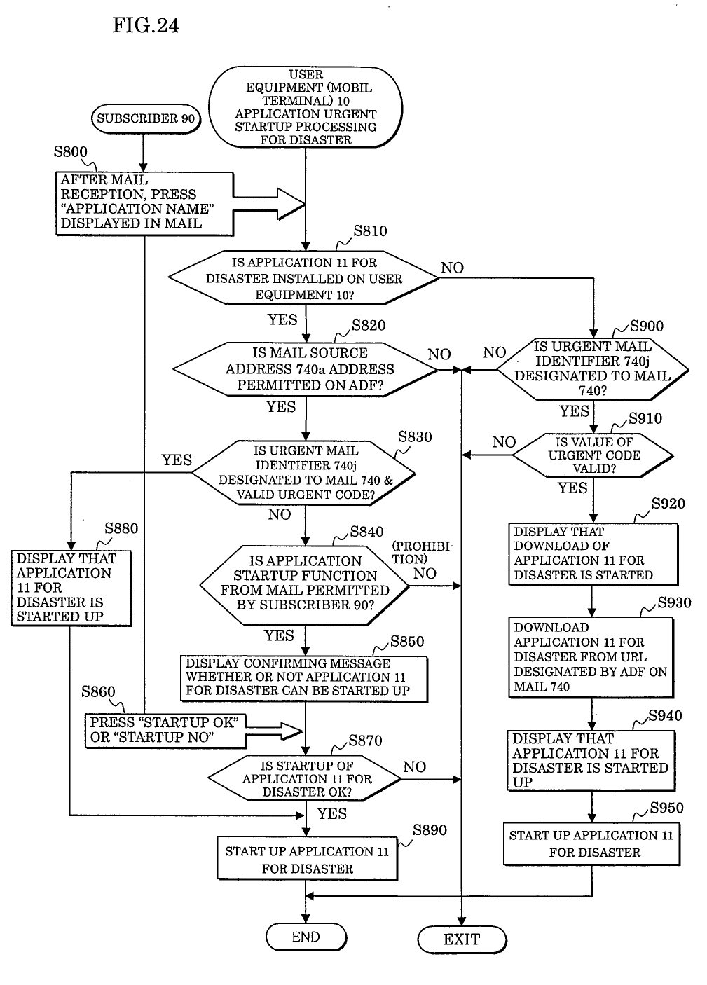

FIG. 24 shows a download operation procedure example (2) of the mobile terminal 10, which is different from the operation procedure shown in FIG. 23. When the urgent startup mail 740 is received, and if the application 11 for disaster has not been installed, it is automatically (almost compulsorily) downloaded. The function of starting up the application 11 for disaster is installed in the application management component 16 (see FIG. 6) in the application execution environment of the mobile terminal 10. The operation procedure example (2) will now be described referring to FIG. 5.

It is to be noted that the application management component 16 has following functions (1)-(4).
(1) List display function of application stored in the terminal 10;
(2) Execution management function of application (function of startup or compulsory termination, application execution environment, and intermediacy with other applications, or the like);
(3) Function of installation or update (version up) of application;
(4) Function of application deletion stored in the terminal 10.
   Step S800: The disaster system center 40 transmits the application urgent startup mail 740 for disaster to the mobile terminal 10.

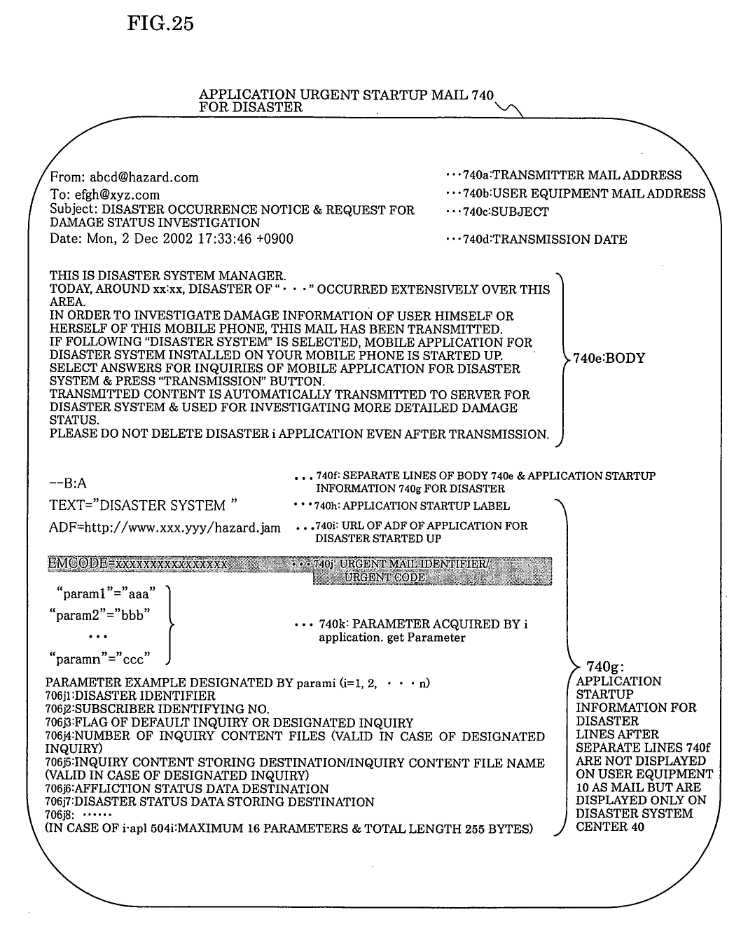

FIG. 25 shows an application urgent startup mail 740 for disaster. The urgent startup mail 740 is different from the startup mail 706 shown in FIG. 16 in that an urgent mail identifier/urgent code 740j is added to the application startup information 740g for disaster.

The urgent mail identifier/urgent code 740j is one means for preventing a download of a virus or the like to the terminal by a malicious mail to be executed. The urgent mail identifier/urgent code 740j is composed of “identifier (EMCODE)” indicating that this mail is an urgent mail and “urgent code” confirming effectiveness of the identifier.

It is to be noted that other various prior art technologies can be used in order to ensure security.

Steps S810, S820, S830, S880, and S890: When the application 11 for disaster is installed, the transmitter mail address 740a is permitted on the ADF, and the urgent mail identifier 740j of the urgent startup mail 740 is an effective urgent code, the application management component 16 of the mobile terminal 10 displays that the startup of the application 11 for disaster is performed, and then starts up the application 11 for disaster.

Steps S830-S850: When the application 11 for disaster is installed and the mail source address 740a is permitted on the ADF, but when the urgent mail identifier 740j of the urgent startup mail 740 is not an effective urgent code and the subscriber 90 permits the application startup function from the mail, the application management component 16 displays the message confirming whether or not the application 11 for disaster can be started up. When the application startup function is not permitted, the processing is ended.

Steps S860, S870, and S890: The subscriber 90 presses “startup OK” or “startup NO”. In case of “startup NO”, the application management component 16 ends the processing. In case of “startup OK”, the application management component 16 starts up the application 11 for disaster.

Steps S810, S900, and S910: When the urgent mail identifier 740j is not designated in the mail 740, or when the urgent code value is not effective, the application management component 16 ends the processing.

It is to be noted that as for the effectiveness of the urgent code, (1) checking whether or not a part of the urgent code matches with a code pattern preliminarily issued, (2) algorithm checking whether or not a calculation result using the number/character included in the urgent code matches with the value preliminarily defined, or the like can be considered.

Steps S810, S900-S950: When the urgent mail identifier 740j is designated in the mail 740 and the urgent code value is effective, the application management component 16 displays that the download of the application 11 for disaster is started, and then downloads the application 11 for disaster from the URL designated by the ADF on the mail 740.

Processing of displaying the confirming message to the subscriber 90 before downloading and of starting the download only when the download is OK may be applied. However, in this description, only the start of the download is displayed to the subscriber 90 since the processing is one for the urgent case and the download is automatically started.

Furthermore, the application management component 16 starts up the application 11 for disaster after having displayed that the downloaded application 11 for disaster is started up.

While the subscriber 90 can set and prohibit the application startup function from the mail, it is supposed in this description that the startup by the urgent mail 730 is executed even if the prohibition is set.

Also, while the processing of displaying the confirming message to the user before the startup and of starting up only when the startup is OK can be considered, in this description the display of startup is performed to the subscriber 90 and the application 11 for disaster is automatically started up since the processing is one for the case of emergency.

As described above, by the disaster system control apparatus executing the disaster system control method according to the present invention, the following effects (1)-(9) can be obtained:
(1) Since information is acquired from an indefinite number of people in the vicinity of the disaster occurrence area, detailed information such as a disaster scale can be grasped in a short time. Also, by acquiring numerous kinds of disaster information such as text information, image, moving image, and voice data, a more detailed disaster status can be grasped;
(2) Since a notice is given to an indefinite number of people around the disaster occurrence area, a secondary disaster or the like can be prevented;
(3) Since a bandwidth control giving preference to data over voice calls is performed in the disaster area, information such as disaster information can be transmitted to more people or from more people, without delay or discard;
(4) By appropriately correcting the bandwidth for data preferentially secured according to a disaster scale (number of afflicted subscribers), the bandwidth can be efficiently used;
(5) Affliction information at an individual level can be acquired at a time of a wide-area large-scale disaster occurrence, and consideration of a rescue activity per individual is made possible;
(6) Since inquiries which a mobile application for disaster performs to a mobile phone subscriber can be set variably, information for a disaster can be acquired;
(7) Disaster information can be timely transmitted to subscribers of the disaster area;
(8) A single disaster system can classify/analyze a plurality of disasters having occurred at the same time;
(9) When inquiries divided are made to the subscribers from the disaster system, affliction information data can be classified/analyzed by inquiry.

What is claimed is:

1. A disaster system control method comprising:
a first step at which a disaster system center provides a bandwidth control apparatus with a disaster occurrence instruction signal; and
a second step at which the bandwidth control apparatus assigns a bandwidth for a packet call in preference to other calls.

2. The disaster system control method as claimed in claim 1, further comprising a third step at which the disaster system center determines a terminal within a disaster occurrence area based on terminal position information, and a fourth step at which the disaster system center gives urgent notice by mail to the determined terminal, indicating that a disaster has occurred.

3. The disaster system control method as claimed in claim 1, further comprising a third step at which the disaster system center determines a terminal within a disaster occurrence area based on terminal position information, and a fourth step at which the disaster system center provides a terminal installing an application for disaster thereon for transmitting/receiving disaster status information at a time of a disaster occurrence with a startup mail for the application for disaster.

4. The disaster system control method as claimed in claim 3, further comprising a fifth step at which the disaster system center provides the bandwidth control apparatus with a correction signal of a preferential assignment of the bandwidth for the packet call based on the disaster status information, and a sixth step at which the bandwidth control apparatus corrects an assignment of giving a preference to the bandwidth for the packet call based on the correction signal.

5. The disaster system control method as claimed in claim 2, wherein the third step provides a home location register with the disaster occurrence area to acquire a terminal number within the area, and provides a mail server with the acquired terminal number to acquire a mail address corresponding to the terminal number.

6. A disaster system control apparatus comprising:
a disaster system center outputting a disaster occurrence instruction signal instructing to assign a bandwidth for a packet call in preference to other calls when a disaster occurrence signal is received; and
a bandwidth control apparatus receiving the disaster occurrence instruction signal and preferentially assigning the bandwidth for the packet call.

7. The disaster system control apparatus as claimed in claim 6, wherein the disaster system center gives urgent notice, by mail, indicating that a disaster has occurred to a terminal within a disaster occurrence area determined based on terminal position information.

8. The disaster system control apparatus as claimed in claim 6, further comprising a terminal installing an application for disaster thereon for transmitting/receiving disaster status information between the disaster system center and the apparatus itself;
the disaster system center determining a terminal within a disaster occurrence area based on terminal position information, and providing the terminal with a startup mail of the application for disaster at a time of a disaster occurrence.

9. The disaster system control apparatus as claimed in claim 8, wherein the disaster system center provides the bandwidth control apparatus with a correction signal of a preferential assignment of the bandwidth for the packet call based on the disaster status information, and the bandwidth control apparatus corrects the preferential assignment the bandwidth for the packet call based on the correction signal.

10. The disaster system control apparatus as claimed in claim 7, wherein the disaster system center provides a home location register with the disaster occurrence area to acquire a terminal number within the area, and provides a mail server with the acquired terminal number to acquire a mail address corresponding to the terminal number.

11. A bandwidth control apparatus comprising:
a disaster occurrence instructing portion inputting a disaster occurrence signal; and
a bandwidth controller assigning a bandwidth for a packet call in preference to other calls when the disaster occurrence instructing portion receives the disaster occurrence signal.

12. The bandwidth control apparatus as claimed in claim 11, wherein the bandwidth controller preferentially assigns a preset bandwidth to the packet call, or corrects the bandwidth for the packet call according to a disaster scale.

13. A disaster system center comprising:
a disaster occurrence instructing portion inputting a disaster occurrence signal; and
a disaster bandwidth controller outputting a disaster occurrence signal instructing to assign a bandwidth for a packet call in preference to other calls when the disaster occurrence instructing portion receives the disaster occurrence signal.

14. A disaster system center comprising:
a disaster system main controller determining a terminal within a disaster occurrence area based on position information of the terminal; and
an urgent notifying processor giving urgent notice, to the terminal within the area, indicating that a disaster has occurred.

15. The disaster system center as claimed in claim 14, further comprising:
an information acquiring portion requesting a terminal number within the disaster occurrence area from a home location register, requesting a mail address corresponding to the terminal number by providing a mail server with the terminal number acquired in response to the request, and providing the disaster system main controller with the acquired mail address;
the urgent notifying processor giving the urgent notice to the mail address.

16. The disaster system center as claimed in claim 14, wherein a disaster system main controller determines a terminal installing thereon an application for disaster for transmitting/receiving disaster status information within a disaster occurrence area based on position information of the terminal, and the urgent notifying processor starts up the application for disaster by transmitting an urgent notice mail for starting up the application for disaster to the terminal at a time of a disaster occurrence and transmits/receives the disaster status information.

17. The disaster system center as claimed in claim 16, wherein the disaster system main controller compiles the disaster status information into a database to be analyzed, and the disaster bandwidth controller transmits a bandwidth correction control signal instructing to assign a bandwidth for a packet call in preference to other calls based on an analysis result.

18. The disaster system center as claimed in claim 17, wherein the disaster system main controller classifies disasters, based on a disaster identifier which identifies a plurality of disasters to be analyzed.

19. The disaster system center as claimed in claim 17, wherein the disaster system main controller analyzes the disaster status information per disaster area and per terminal.

20. The disaster system center as claimed in claim 17, wherein the urgent notifying processor transmits the analysis result to a terminal within a disaster occurrence area.

21. A disaster system center comprising:
a preregistered information database preliminarily holding an identifier of a terminal installing thereon an application for disaster which transmits/receives disaster status information;
a disaster system main controller determining a terminal within a disaster occurrence area based on position information of a terminal; and
an urgent notifying processor outputting a download request requesting a download of an application for disaster to a terminal within the disaster occurrence area installing thereon no application for disaster.

22. The disaster system center as claimed in claim 21, wherein the urgent notifying processor compulsorily downloads the application for disaster to the terminal within the disaster occurrence area.

23. The disaster system center as claimed in claim 21, wherein the urgent notifying processor outputs an application startup request for disaster requesting a startup of the application for disaster which the terminal within the disaster occurrence area installs thereon.

24. A terminal comprising:
a transceiver receiving an application startup request for disaster at a time of a disaster occurrence; and
an application for disaster transmitting/receiving disaster status information started up when the transceiver receives the startup request.

25. The terminal as claimed in claim 24, wherein the disaster status information comprises any one of disaster status data responded by subscribers to inquiries from an application for disaster, text information of a comment on disaster statuses freely inputted by subscribers, image data of surrounding disaster statuses taken by subscribers, moving image data of surrounding disaster statuses or disaster statuses of subscribers themselves taken by the subscribers, and voice data describing disaster statuses by voice of subscribers.

26. The terminal as claimed in claim 24, wherein the application for disaster is started up only when the application startup request for disaster includes an urgent code.

27. A terminal comprising:
a transceiver receiving a download request requesting a download of an application for disaster; and
an application management portion downloading an application for disaster when the transceiver receives the download request.

28. The terminal as claimed in claim 27, wherein the application management portion downloads an application for disaster only when an urgent code identifier is included in the download request.

29. The disaster system control method as claimed in claim 3, wherein the third step provides a home location register with the disaster occurrence area to acquire a terminal number within the area, and provides a mail server with the terminal number acquired to acquire a mail address corresponding to the terminal number.

30. The disaster system control apparatus as claimed in claim 8, wherein the disaster system center provides a home location register with the disaster occurrence area to acquire a terminal number within the area, and provides a mail server with the terminal number acquired to acquire a mail address corresponding to the terminal number.
